(19) United States
(12) Patent Application Publication
(10) Pub. No.: US 2013/0259606 A1
(43) Pub. Date: Oct. 3, 2013

(54) INFORMATION PROCESSING APPARATUS, INFORMATION PROCESSING METHOD, AND NON-TRANSITORY COMPUTER-READABLE MEDIUM

(71) Applicant: CANON KABUSHIKI KAISHA, Tokyo (JP)

(72) Inventor: Hiroyuki Kayama, Yokohama-shi (JP)

(73) Assignee: CANON KABUSHIKI KAISHA, Tokyo (JP)

(21) Appl. No.: 13/785,310

(22) Filed: Mar. 5, 2013

(30) Foreign Application Priority Data
Mar. 28, 2012 (JP) 2012-074886

(51) Int. Cl. B42C 99/00

(52) U.S. Cl. CPC B42C 99/00
USPC 412/9

(57) ABSTRACT

An information processing apparatus for generating print data based on document data, comprises: a receiving unit configured to receive, in bookbinding printing for generating a book by folding a bundle of a plurality of sheets overlapping each other into two, an instruction to insert an insertion sheet to the folded bundle; and a generation unit configured to generate, in response to the instruction to insert the insertion sheet which has been received by the receiving unit, print data for outputting a book in which the insertion sheet has been inserted to inner side of the folded bundle by stacking a bundle of printed materials based on settings of the bookbinding printing and the insertion sheet on each other, and folding the bundle into two.

### BACKGROUND OF THE INVENTION

1. Field of the Invention

The present invention relates to an information processing apparatus, an information processing method, and a non-transitory computer-readable medium.

2. Description of the Related Art

An application or printer driver can receive bookbinding printing, as one print setting, for generating a book by bundling a plurality of sheets, folding the bundle into two, and binding the bundle.

There has been conventionally known a technique of setting insertion of the external sheet of a book, that is, insertion of a sheet at a front cover position in bookbinding printing (see, for example, Japanese Patent Laid-Open No. 2008-165816). That is, it is possible to use a sheet different from other sheets (the body) at the front cover position in bookbinding printing. With this technique, a color printer can preprint a colored sheet in color as the front cover of a book, and then a monochrome printer can be used to perform bookbinding printing while inserting the preprinted sheet at the front cover position from the monochrome printer.

There is known a technique in which in a document editing operation, a conventional document processing system holds information on a link to document data as page information when dividing a page, and moves the pages obtained by the division operation when moving the divided page (see, for example, Japanese Patent Laid-Open No. 2005-108107). That is, for a document in which one page is formed by a plurality of pieces of page information, edit processing is executed for all relevant pages according to an edit operation for a specific page.

The above-described conventional technique can insert a sheet at the front cover position in bookbinding printing but cannot insert a sheet other than the front cover, and thus the user cannot readily generate desired printed materials. Furthermore, in bookbinding printing, if a plurality of pages are laid out on one sheet, processing cannot be performed for each specific group laid out on the sheet in an edit operation, and thus the user cannot readily generate desired printed materials. The present application enables the user to readily generate desired printed materials in bookbinding printing.

### SUMMARY OF THE INVENTION

According to one aspect of the present invention, there is provided an information processing apparatus for generating print data based on document data, comprising: a receiving unit configured to receive, in bookbinding printing for generating a book by folding a bundle of a plurality of sheets overlapping each other into two, an instruction to insert an insertion sheet to the folded bundle; and a generation unit configured to generate, in response to the instruction to insert the insertion sheet which has been received by the receiving unit, print data for outputting a book in which the insertion sheet has been inserted to inner side of the folded bundle by stacking a bundle of printed materials based on settings of the bookbinding printing and the insertion sheet on each other, and folding the bundle into two.

According to another aspect of the present invention, there is provided an information processing method of generating print data based on document data, comprising: receiving, in bookbinding printing for generating a book by folding a bundle of a plurality of sheets overlapping each other into two, an instruction to insert an insertion sheet to the folded bundle; and generating, in response to the instruction to insert the insertion sheet which has been received in the receiving step, print data for outputting a book in which the insertion sheet has been inserted to inner side of the folded bundle by stacking a bundle of printed materials based on settings of the bookbinding printing and the insertion sheet on each other, and folding the bundle into two.

According to another aspect of the present invention, there is provided a non-transitory computer-readable medium storing a program for causing a computer to function as a receiving unit configured to receive, in bookbinding printing for generating a book by folding a bundle of a plurality of sheets overlapping each other into two, an instruction to insert an insertion sheet to the folded bundle; and a generation unit configured to generate, in response to the instruction to insert the insertion sheet which has been received by the receiving unit, print data for outputting a book in which the insertion sheet has been inserted to inner side of the folded bundle by stacking a bundle of printed materials based on settings of the bookbinding printing and the insertion sheet on each other, and folding the bundle into two.

According to the present invention, the user can readily output desired printed materials in bookbinding printing.

Further features of the present invention will become apparent from the following description of exemplary embodiments (with reference to the attached drawings).

### BRIEF DESCRIPTION OF THE DRAWINGS

FIG. 1 is a block diagram showing an example of the software configuration of a document processing system;

FIG. 2 is a block diagram showing an example of a hardware configuration;

FIG. 3 is a view showing an example of the structure of a book file;

FIGS. 4A and 4B are tables for explaining a list of attribute information associated with book attributes;

FIG. 5 is a table for explaining a list of attribute information associated with section attributes;

FIG. 6 is a table for explaining a list of attribute information associated with page attributes;

FIG. 7 is a flowchart illustrating processing of opening a book file;

FIG. 8 is a view showing an example of a UI screen when a new book file is opened;

FIG. 9 is a view showing an example of a UI screen when an existing book file is opened;

FIG. 10 is a flowchart illustrating processing of importing an electronic document file in a book file;

FIG. 11 is a flowchart illustrating electronic document file generation processing;

FIG. 12 is a view showing an example of a UI screen for bookbinding printing settings;

FIG. 13 is a view showing an example of a UI screen for insertion sheet and bind-in sheet settings in bookbinding printing;

FIG. 14 is a flowchart illustrating bind-in sheet setting processing in bookbinding printing;

FIG. 15 is a flowchart illustrating page movement/deletion processing associated with bookbinding printing;

FIG. 16 is a view showing an example of a UI screen displayed for page movement/deletion in bookbinding printing;

FIG. 17 is a flowchart illustrating bookbinding printing imposition processing;

FIG. 18 is a view showing an example of a UI screen displayed when performing the bookbinding printing imposition processing;

FIGS. 19A and 19B are flowcharts illustrating bookbinding printing imposition processing according to the second embodiment;

FIG. 20 is a view showing an example of a UI screen displayed when performing the bookbinding printing imposition processing according to the second embodiment;

FIGS. 21A and 21B are views each showing a display example of a UI screen when moving a specific document page in bookbinding printing settings according to the first embodiment; and

FIGS. 22A and 22B are views each showing a display example of a UI screen when moving a specific document page in bookbinding printing settings according to the first embodiment.

### DESCRIPTION OF THE EMBODIMENTS

Modes for carrying out the present invention will be described below with reference to the accompanying drawings.

### First Embodiment

[System Overview]

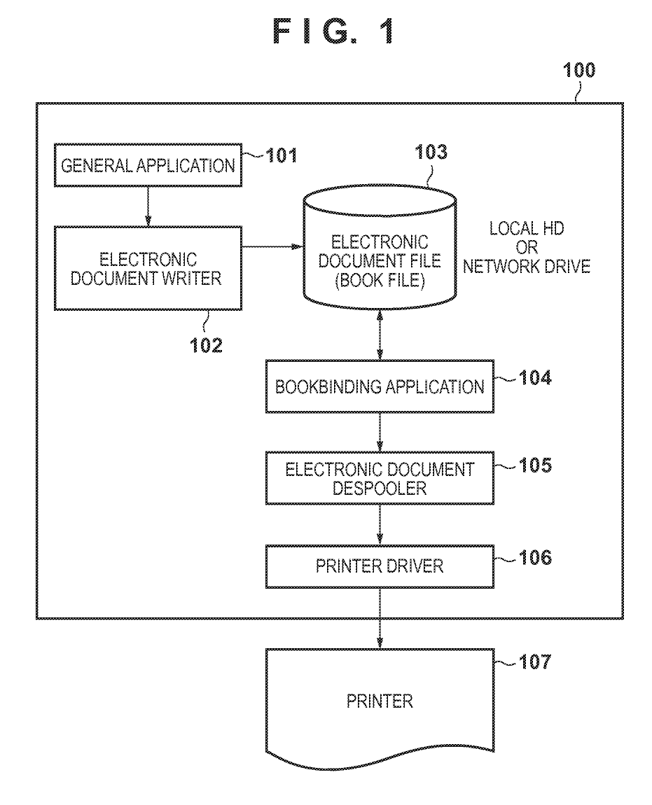

A document processing system according to the first embodiment of the present invention will be described with reference to FIGS. 1 to 18. This document processing system converts a data file generated by a general application into an electronic document file using an electronic document writer. A bookbinding application provides a function capable of editing the electronic document file. This function will be described in detail below.

(System Configuration and Operation)

FIG. 1 is a block diagram showing the software configuration of the document processing system according to the embodiment of the present invention. The document processing system is implemented by a computer (to be also referred to as a host computer hereinafter) which is an embodiment of a document processing apparatus (information processing apparatus) according to the embodiment. A general application 101 is an application program which provides a word processing function, a spreadsheet function, a photo retouch function, a draw or paint function, a presentation function, a text edit function, and the like. The general application 101 has a printing function for an operating system (OS).

The application programs use a predetermined interface (generally called GDI) provided by the OS to print application data (document data) such as generated document data or image data. That is, in order to print generated document data, the general application 101 transmits an output command (called a GDI function) in a predetermined format dependent on the OS to an output module of the OS which provides an interface. Upon receiving this output command, the output module converts the output command into a format processable by an output device such as a printer as an image forming apparatus, and outputs the converted command (called a DDI (Device Driver Interface) function).

Since the format processable by the output device differs depending on the type, manufacturer, and model of output device, a device driver is provided for each output device. The OS generates print data by converting the command using the corresponding device driver, and compiles the data using JL (Job Language), thereby generating a print job. If the Windows® OS available from Microsoft is used, a module called GDI (Graphic Device Interface) corresponds to the above-described output module.

An electronic document writer 102 is an improvement of the above-described device driver, and is a software module provided to implement the document processing system. Note that the electronic document writer 102 does not aim at output for a specific output device. The electronic document writer 102 generates an electronic document file 103 by converting an output command into a format processable by a bookbinding application 104 and a printer driver 106 (both of which will be described later). The format (to be referred to as an “electronic document format” hereinafter) obtained by the conversion processing by the electronic document writer 102 is not specifically limited as long as it is possible to express a document in a detailed form for each page. As an actual standard electronic document format, it is possible to use, for example, PDF (Portable Document Format) available from Adobe Systems or SGML (Standard Generalized Markup Language).

To cause the general application 101 to use the electronic document writer 102, the electronic document writer 102 is designated as a device driver to be used for output, and then printing is executed. Note that the electronic document file generated by the electronic document writer 102 does not have a complete electronic document file format. For this reason, the bookbinding application 104 designates the electronic document writer 102 as a device driver, and application data is converted into an electronic document file under the management of the bookbinding application 104. The bookbinding application 104 completes a new incomplete electronic document file generated by the electronic document writer 102 as an electronic document file having a format to be described later.

If it is necessary to clearly identify the state of each electronic document file, each file will be referred to as follows. A file generated by the electronic document writer 102 will be referred to as an “electronic document file”. On the other hand, an electronic document file given a structure by the bookbinding application will be referred to as a “book file”. If it is not necessary to specifically discriminate such files, a document file generated by an application, an electronic document file, and a book file will be collectively referred to as “document files (or document data)”.

As described above, by designating the electronic document writer 102 as a device driver and causing the general application 101 to print the data, the application data is converted into an electronic document format for each page defined by the general application 101. A storage medium such as a hard disk then stores the application data as the electronic document file 103. Note that the hard disk may be the local drive of the computer which implements the document processing system according to this embodiment. Alternatively, when the system is connected to a network, the hard disk may be a drive provided on the network. Each page constituting application data will be referred to as a “logical page” or “document page” hereinafter.

The bookbinding application 104 provides the user with a function of reading and editing the “electronic document file” or “book file” 103. The bookbinding application 104 provides a function of editing the contents (document images) of each page, and that of editing the structure of a book or section (to be described later) constituted by pages each as the minimum unit.

To print the book file edited by the bookbinding application 104, the bookbinding application 104 activates an electronic document despooler 105. The electronic document despooler 105 is a program module installed on the computer together with the bookbinding application 104. Furthermore, the electronic document despooler 105 is a module used to output drawing data to the printer driver to print a document (book file) to be used by the bookbinding application 104. The electronic document despooler 105 reads out a designated book file from the hard disk. To print each page in a format described in the designated book file, the electronic document despooler 105 generates an output command complying with the output module of the OS described above, and outputs the command to the output module (not shown). At this time, the printer driver 106 for a printer 107 used as an output device is designated as a device driver. The output module (not shown) uses the printer driver 106 of the designated printer 107 to convert the received output command into print data interpretable by the printer 107. The converted print data is transmitted to the printer 107, which then prints an image corresponding to the print data.

(Hardware Configuration)

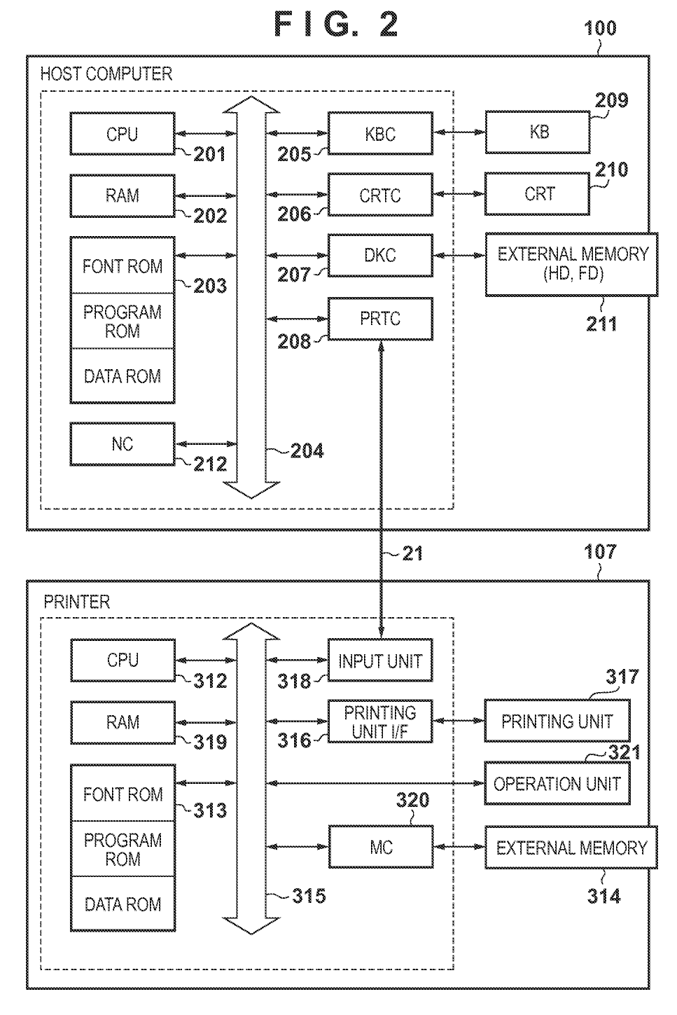

The configuration of a document management system including a host computer 100 and the printer 107, which is applicable to the embodiment, will be described. FIG. 2 is a block diagram showing an example of the hardware configuration of the document processing system according the embodiment. Note that the present invention is applicable to a single device, a system constituted by a plurality of devices, or a system which performs processing while being connected via a network such as a LAN or WAN as long as the functions of the embodiment can be implemented.

Referring to FIG. 2, the host computer 100 includes a CPU 201 which processes a document including graphics, images, characters, and tables (including spreadsheets) based on document processing programs and the like stored in the program ROM of a ROM 203 or an external memory 211. The CPU 201 collectively controls respective devices connected to a system bus 204. The program ROM of the ROM 203 or the external memory 211 stores an operating system program serving as the control program of the CPU 201, and the like. The font ROM of the ROM 203 or the external memory 211 stores font data used for the above document processing, and the like. The data ROM of the ROM 203 or the external memory 211 stores various data used for the above document processing. A RAM 202 functions as a main memory, a work area, or the like for the CPU 201.

A keyboard controller (KBC) 205 controls a key input operation from a keyboard (KB) 209 or a pointing device (not shown). A CRT controller (CRTC) 206 controls display of a CRT display (CRT) 210. A disk controller (DKC) 207 controls access to the external memory 211 such as a hard disk (HD) or floppy® disk (FD). The external memory 211 stores a boot program, various applications, font data, user files, edit files, print data generation programs (to be referred to as printer drivers hereinafter), and the like. A printer controller (PRTC) 208 is connected to the printer 107 via a bidirectional interface 21, and executes communication control processing with the printer 107. An NC 212 is connected to a network, and executes communication control processing with other devices connected to the network.

Note that the CPU 201 executes processing of rasterizing outline fonts into, for example, a display information RAM set on the RAM 202, thereby enabling WYSIWYG on the CRT 210. The CPU 201 opens various registered windows based on a command instructed by a mouse cursor (not shown) or the like on the CRT 210, and executes various data processes. To execute printing, the user can open windows associated with print settings, and makes settings of a printer and settings of an information processing method for a printer driver including selection of a printing mode.

A CPU 312 controls the printer 107. The CPU 312 of the printer outputs an image signal as output information to a printing unit (printer engine) 317 based on a control program stored in the program ROM of a ROM 313, a control program stored in an external memory 314, or the like. The program ROM of the ROM 313 stores the control program of the CPU 312, and the like. The font ROM of the ROM 313 stores font data used to generate the output information, and the like. For a printer having no external memory 314 such as a hard disk, the data ROM of the ROM 313 stores information used by the host computer 100, and the like.

The CPU 312 can communicate with the host computer 100 via an input unit 318, and notify the host computer 100 of the information and the like of the printer 107. A RAM 319 functions as a main memory, a work area, or the like for the CPU 312, and can expand the memory capacity by an optional RAM connected to an expansion port (not shown). Note that the RAM 319 is used as an output information rasterization area, environment data storage area, NVRAM, or the like. A memory controller (MC) 320 controls access to the above-described external memory 314 such as a hard disk (HD) or IC card. The external memory 314 is connected as an option, and stores font data, emulation programs, form data, and the like. An operation panel 321 includes operation switches and LED indicators.

The present invention is not limited to one external memory 314, and the system may include a plurality of external memories. A plurality of external memories may be connected, which include an optional font card in addition to a built-in font card and store programs for interpreting the printer control languages of different language systems. In addition, the printer 107 may include an NVRAM (not shown) to store printer mode setting information from the operation panel 321.

Note that the hardware configuration of each apparatus of the document processing system shown in FIG. 2 is merely an example, and the present invention is not limited to this. Each apparatus may include other components.

[Electronic Document Data Format Example]

Before the detailed description of the bookbinding application 104, the data format of the book file generated by the bookbinding application 104 will be described.

(Data Structure)

The book file has a three-layered structure similar to a paper-medium book. The upper layer is called a “book”, imitates one book, and defines the attributes of the entire book. The intermediate layer corresponds to a section in the book, and is called a “section”. As for each section, its attributes can be individually defined. The lower layer is a “page”, and corresponds to each page defined by an application program. As for each page, its attributes can be individually defined. Note that one “book” may include one or a plurality of “sections”, and one “section” can include one or a plurality of “pages”.

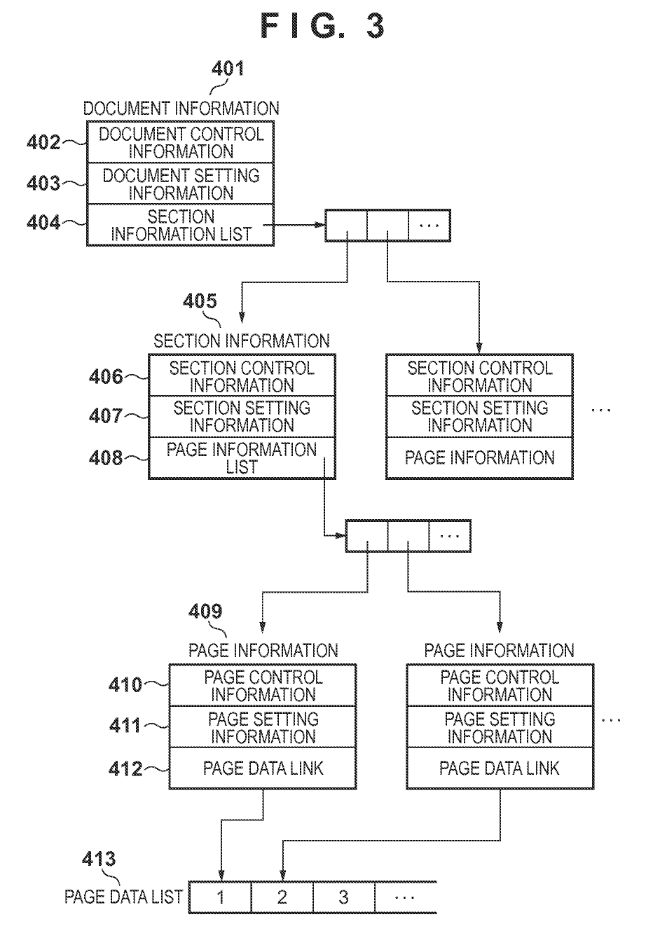

FIG. 3 is a view schematically showing an example of the book file format. In this example, “book”, “section”, and “page” in the book file are represented by corresponding nodes, respectively. One book file includes one “book”. The “book” and “section” form a concept for defining the structure of the “book”, and contain, as entities, defined attribute values and links to lower layers. The “page” contains, as an entity, the document data of each “page” output from the application program. In addition to an attribute value, the “page” contains the entity (document data) of a document page and a link to each document data. Note that a print page to be output onto a paper medium or the like may include a plurality of document pages. This structure is displayed not by a link but by an attribute on each of the layers of “book”, “section”, or “page”.

In FIG. 3, the book file need not be one complete book, and thus “book” is generalized as “document”.

The book file has document information 401 on the top layer. The document information 401 is broadly divided into three parts 402 to 404. The document control information 402 holds information such as the path name of the document file in a file system. The document setting information 403 holds layout information such as page layout information and the function setting information of the printer such as stapling information, and corresponds to the attributes of the book. The section information list 404 holds a set of sections constituting the document in a list format. The list includes section information 405.

The section information 405 is broadly divided into three parts 406 to 408. The section control information 406 holds information such as the name of a corresponding section. The section setting information 407 holds page layout information and stapling information unique to the corresponding section, and corresponds to section attributes. Holding setting information for each section enables to generate a document with a complicated layout in which the first section has a 2-up layout and other sections have a 4-up layout. The page information list 408 holds a set of document pages constituting each section in a list format. The page information list 408 points to page information 409.

The page information 409 is broadly divided into three parts 410 to 412. The page control information 410 holds information such as a page number displayed on a tree. The page setting information 411 holds information such as rotation angle information and page layout position information, and corresponds to document page attributes. The page data link 412 points to document data corresponding to a corresponding page. In this example, the page information 409 has no document data but has only link information. A page data list 413 includes actual document data.

Each attribute and a value designated in the attribute according to the embodiment will be exemplified below. Note that attributes to be described below are merely examples, and the present invention is not limited to them. The attributes may be changed according to the function of the document processing system.

(Book Attributes)

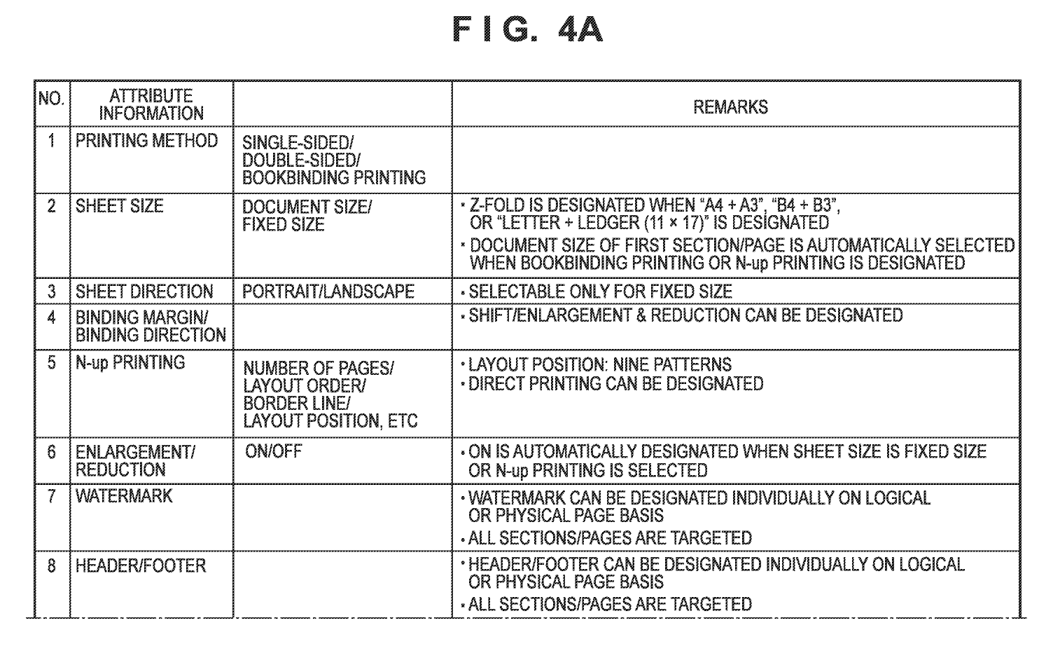

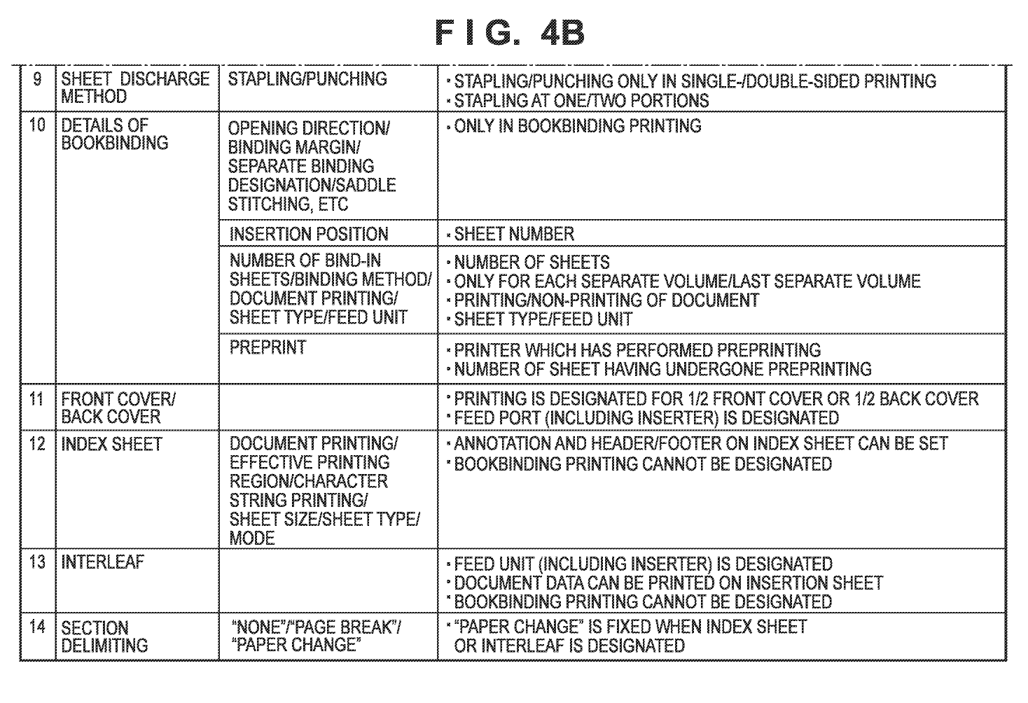

FIGS. 4A and 4B show a list for explaining an example of book attributes (document setting information 403). As for an item which can be redundantly defined on a lower layer, in general, the attribute value of the lower layer is preferentially adopted. As for an item included in only the book attributes, a value defined in the book attribute is effective throughout the book. Note that an item redundantly defined on a lower layer is a default value used when this item is not defined on the lower layer. Whether an attribute value on the lower layer is preferentially adopted may be selected via a user interface (not shown). Note that each item shown in FIGS. 4A and 4B does not correspond to one specific item, and may include a plurality of relevant items.

Items unique to the book attributes are five items: “printing method”, “details of bookbinding”, “front cover/back cover”, “interleaf”, and “section delimiting”. These items are defined throughout the book.

For the “printing method” attribute, it is possible to designate three values: “single-sided printing”, “double-sided printing”, and “bookbinding printing”. In this case, “bookbinding printing” is a method of printing data in a format which allows bookbinding by bundling a separately designated number of sheets, folding the bundle into two, and binding the bundle.

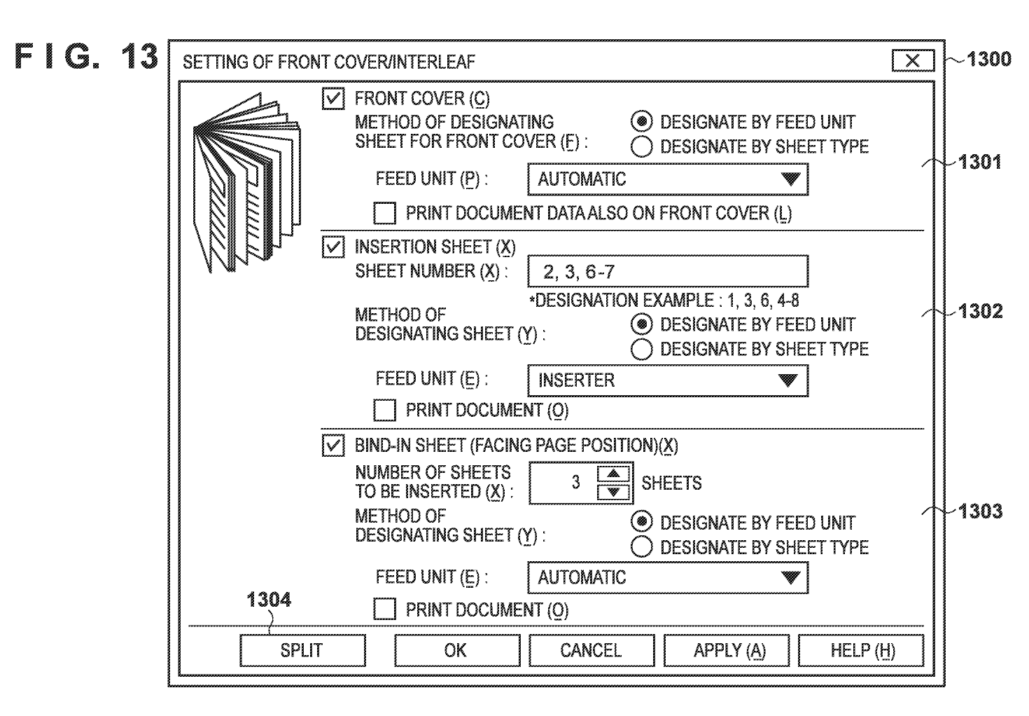

For the “details of bookbinding” attribute, it is possible to designate “opening direction”, “binding margin”, “number of sheets to be bundled (separate binding method)”, “saddle stitching (stapling/no-stapling in bookbinding)”, and the like if “bookbinding printing” is designated in the “printing method” attribute. Furthermore, for the “details of bookbinding” attribute, it is possible to set information about an insertion sheet via a user interface (UI) shown in FIG. 13 (to be described later). This implements a unit of receiving settings of insertion of a sheet. Note that “insertion sheet” indicates a sheet which is different from the body and is inserted in the middle of the book. Examples of setting items of an insertion sheet include a sheet type (for example, colored sheet) and a sheet number (which indicates a position where a sheet is to be inserted). The “details of bookbinding” attribute includes designation for inserting a “bind-in sheet”. As “bind-in sheet” attributes, it is possible to designate, through a UI screen 1300 shown in FIG. 13 (to be described later), the number of bind-in sheets, a binding method (for each separate volume/only the last separate volume) in separate binding, printing/non-printing of document data, a sheet type, the feed unit of the printer 107, and the like.

The “details of bookbinding” attribute includes “preprint” attributes. The “preprint” attributes include information of the name of a printer which executed partial printing by designating a specific sheet number in the past, and the sheet number. The “preprint” attributes are used when printing is performed using a preprinted sheet while inserting an insertion sheet or bind-in sheet in the middle of the bundle of sheets. More specifically, a preprinted sheet output from a color printer can be set in a monochrome printer, and the monochrome can print data while inserting the preprinted sheet between sheets. Note that a “bind-in sheet” indicates a sheet existing at a “binding position (facing page position)”. The “binding position (facing page position)” indicates the central position when binding a bundle. That is, a “bind-in sheet” indicates a sheet bound at the facing page position. The number of “bind-in sheets” is not limited to one, and there may be a plurality of “bind-in sheets”. Furthermore, a document page may be printed on a “bind-in sheet”. In general, a “bind-in sheet” is used to insert a sheet (a plurality of sheets) whose type is different from the body in the middle of a book in an open state.

The “front cover/back cover” attribute includes designation of adding sheets as front and back covers when an electronic document file complied as a book is printed, and designation of contents to be printed on the added sheets. Note that if “bookbinding printing” is designated in the “printing method” attribute, “only front cover” is designated.

The “interleaf” attribute includes, as a section break, designation of an inserter as the feed unit of the printer 107, or ON/OFF of insertion of a sheet fed from a paper feed cassette. When an interleaf is inserted, the attribute includes designation of a feed unit. Note that in this embodiment, the inserter is used as a feed unit for discharging a sheet without printing any image, and the paper feed cassette is used as a feed unit for printing an image to discharge a sheet.

The “section delimiting” attribute includes designation of whether to use a new sheet, use a new print page, or do nothing particular at a section break. In single-sided printing, “use of new sheet” is equivalent to “use of new print page”. In double-sided printing, designating “use of new sheet” inhibits consecutive sections from being printed on one sheet, whereas designating “use of new print page” allows consecutive sections to be printed on the front and back sides of one sheet.

(Section Attributes)

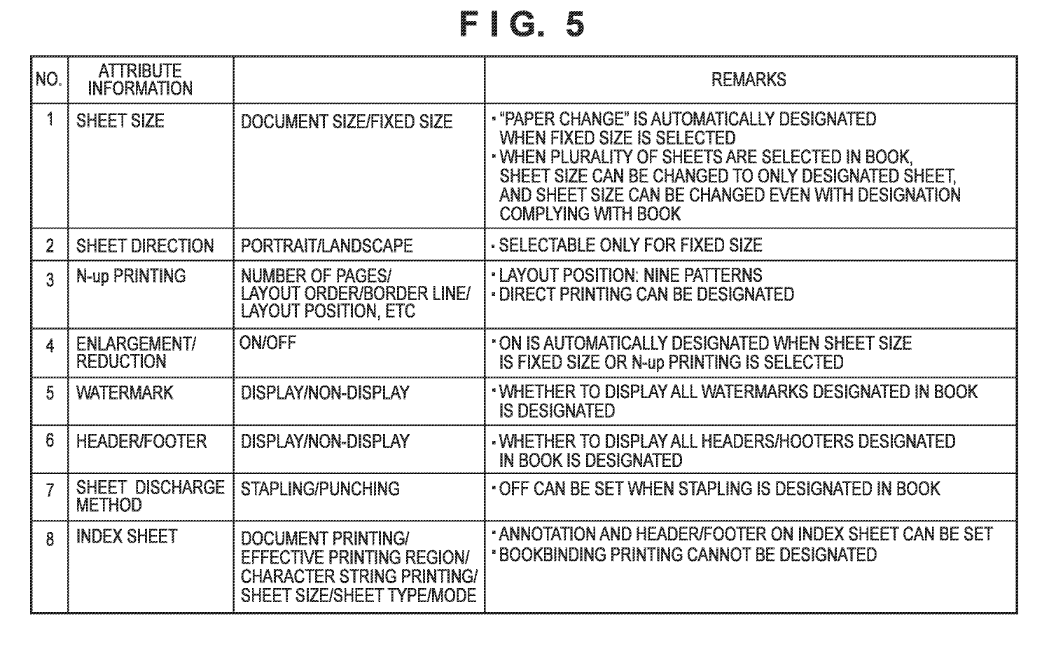

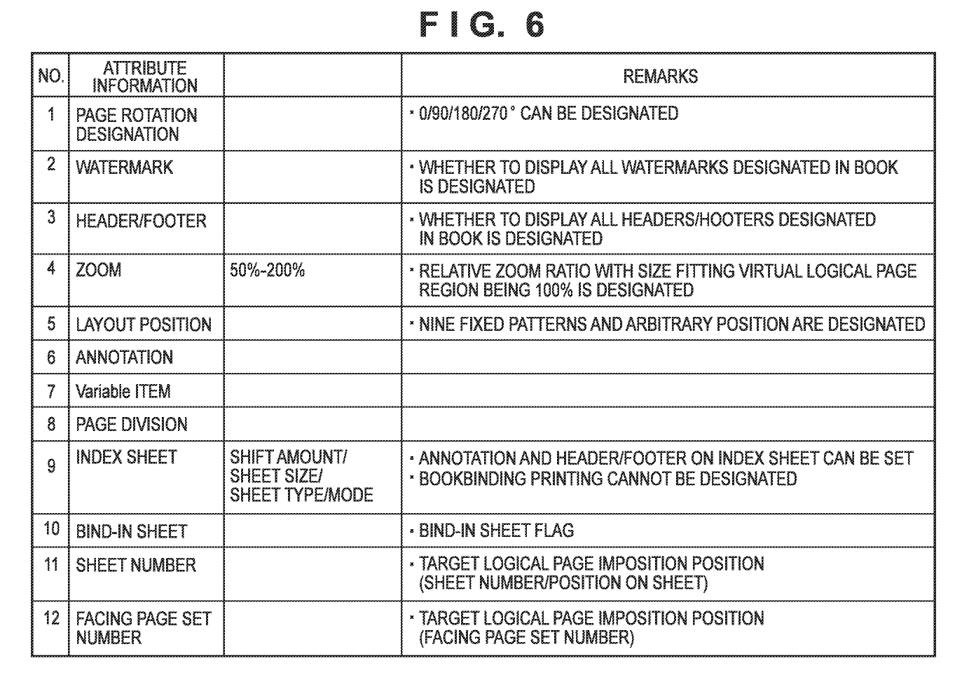

FIG. 5 shows a list of examples of the section attributes (section setting information 407). FIG. 6 shows a list of examples of the page attributes (page setting information 411). The relationship between the section attributes and the page attributes is the same as that between the book attributes and lower layer attributes.

As for the section attributes shown in FIG. 5, there is no item unique to the section, and all items overlap those of the book attributes. If the definition of a given section attribute is different from that of a corresponding book attribute, a value defined in the section attribute is preferentially used. Whether the attribute value of a lower layer is preferentially used may be selectable.

There are eight items common to the book and section attributes: “sheet size”, “sheet direction”, “N-up printing designation”, “enlargement/reduction”, “watermark”, “header/footer”, “sheet discharge method”, and “index sheet”. The “N-up printing designation” attribute is an item for designating the number of document pages included in one print page. Printing position layouts which can be designated here include 1×1, 1×2, 2×2, 3×3, and 4×4. The “paper discharge method” attribute is an item for designating whether to staple discharged sheets. The effectiveness of this attribute depends on whether the printer has a stapling function.

(Page Attributes)

As for the page attributes shown in FIG. 6, items unique to a page include “page rotation designation”, “zoom”, “layout position”, “annotation”, “Variable item”, “page division”, “bind-in sheet”, “sheet number”, and “facing page set number”. The “page rotation designation” attribute is an item for designating a rotational angle when a document page is laid out on a print page. The “zoom” attribute is an item for designating the zoom ratio of a document page. The zoom ratio is designated with reference to a virtual logical page region size=100%. “Virtual logical page region” is a region occupied by one document page when document pages are laid out in accordance with N-up designation or the like. For example, the virtual logical page region is a region corresponding to one print page with the layout of 1×1, or a region obtained by reducing each side of one print page to about 70% with the layout of 1×2.

The “bind-in sheet” attribute is a flag (ON/OFF) indicating whether a target page is laid out at a bind-in sheet position. The “bind-in sheet” attribute indicates whether a target document page is imposed as a bind-in sheet. The “sheet number” attribute indicates a sheet number representing a position where a target document page is laid out. The “facing page set number” attribute indicates a facing page set number representing a position where a target document page is laid out in bookbinding printing. The “sheet number” and “facing page set number” attributes are used in processing of editing a page (moving the position of document data or deleting document data).

Attributes common to “book”, “section”, and “page” are the “watermark”, “header/footer”, and “index sheet” attributes. “Watermark” is a separately designated image or character string printed on data generated by an application. “Header and footer” are watermarks printed on the upper and lower margins of each page, respectively. For the “header and footer”, items such as a page number, and date and time which can be designated by variables are prepared.

The contents which can be designated in the “watermark” and “header/footer” attributes are common to “section” and “page” but are different from those for “book”. For “book”, it is possible to set the contents of “watermark” and “header/footer”, and designate how to print “watermark” or “header/footer” throughout the book. To the contrary, for “section” or “page”, it is possible to designate whether to print, on the section or page, the “watermark” and “header/footer” set for the book.

The “index sheet” attribute enables to designate for each page whether to insert an index sheet (ON/OFF).

[Generation of Book File]

A book file has the structure and contents described above with reference to FIG. 3. A procedure of generating a book file by the bookbinding application 104 and the electronic document writer 102 will now be described. A book file is generated as part of a book file edit operation by the bookbinding application 104.

(Book File Open)

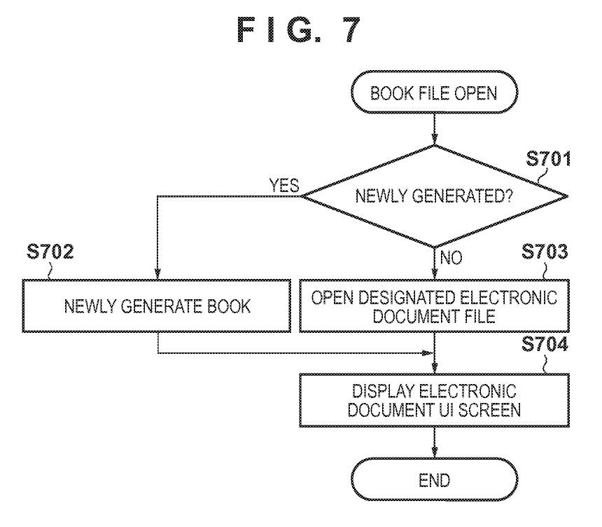

FIG. 7 is a flowchart illustrating a procedure of opening a book file by the bookbinding application 104 according to this embodiment. Note that flowcharts in this application are implemented when the CPU 201 reads out the programs of each flowchart from the external memory 211 to execute them.

The bookbinding application 104 determines first whether a book file to be opened is one to be newly generated or an existing one (step S701). If the book file is one to be newly generated (YES in step S701), the bookbinding application 104 newly generates a book file including no section (step S702). In the example shown in FIG. 3, the newly generated book file is a book node which has only the document information 401 without any link to a section node (section information list 404). As the book attributes (document setting information 403), a set of attributes defined in advance for generation of a new book file are applied. The bookbinding application 104 then displays a UI screen for editing the new book file (step S704).

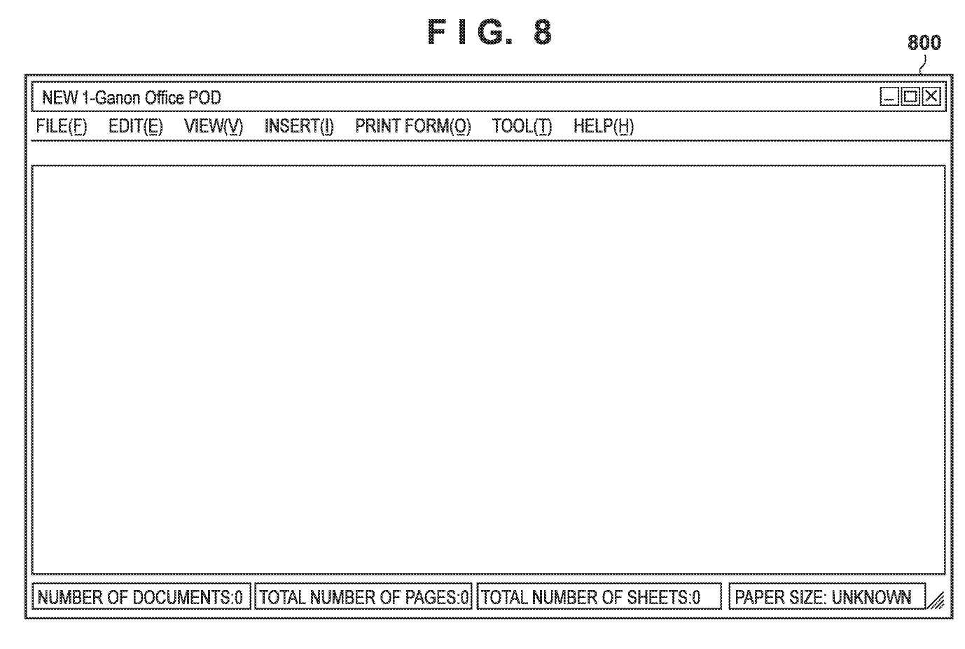

FIG. 8 shows a display example of a UI screen when a book file is newly generated. In this case, a UI screen 800 does not display any information corresponding to the contents of the book file because the book file does not have any substantial contents.

On the other hand, if there is an existing book file (NO in step S701), the bookbinding application 104 opens the designated book file (step S703) and displays a UI screen according to the structure, attributes, and contents of the book file.

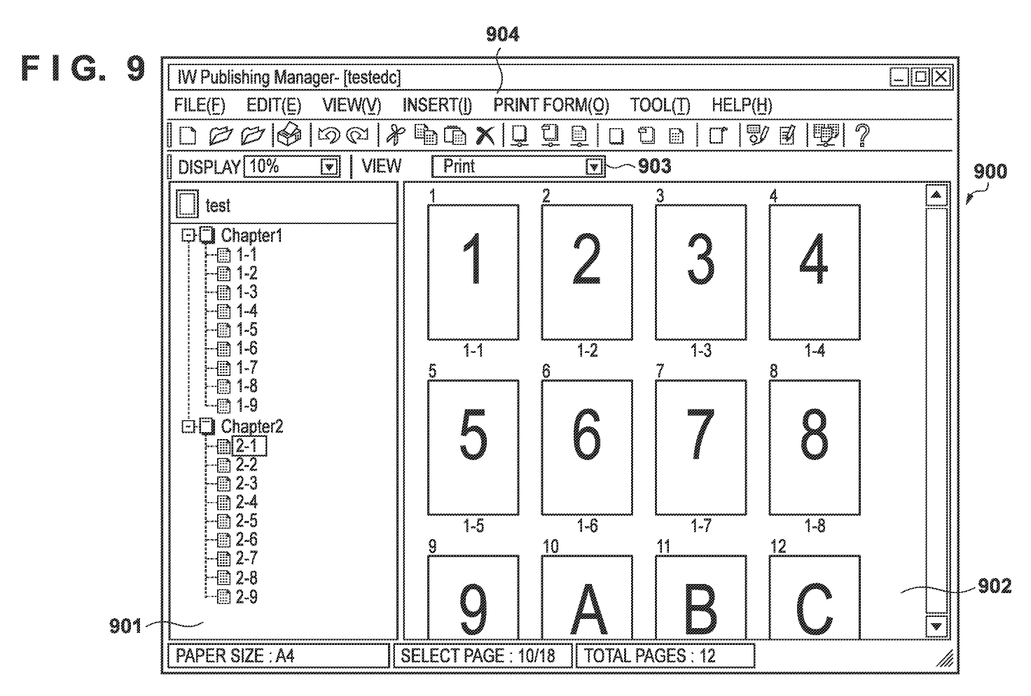

FIG. 9 shows a display example of a UI screen according to the contents of a book file. A UI screen 900 includes a tree portion 901 representing a book structure, and a preview portion 902 displaying a printed state. The tree portion 901 displays sections included in the book and pages included in each section so as to identify a tree structure, as shown in FIG. 3. Pages displayed in the tree portion 901 are document pages. The preview portion 902 displays reduced print page contents. The display order reflects the book structure. The contents of the preview portion 902 can be switched according to designation of View 903. Types of View 903 include “Original” for displaying the contents of document pages intact, “Print” for displaying printed output sheets having undergone processing such as stapling, punching, and bookbinding, and “Output Paper” for displaying each print sheet.

Application data which has been converted into an electronic document file by the electronic document writer 102 can be added as a new section to the opened book file. This function will be referred to as an “electronic document import function”. It is possible to give an entity to the book file newly generated according to the procedure shown in FIG. 7 by adding a section using the electronic document import function. This function is activated by dragging and dropping application data on the screen shown in FIG. 8 or 9.

(Electronic Document Import)

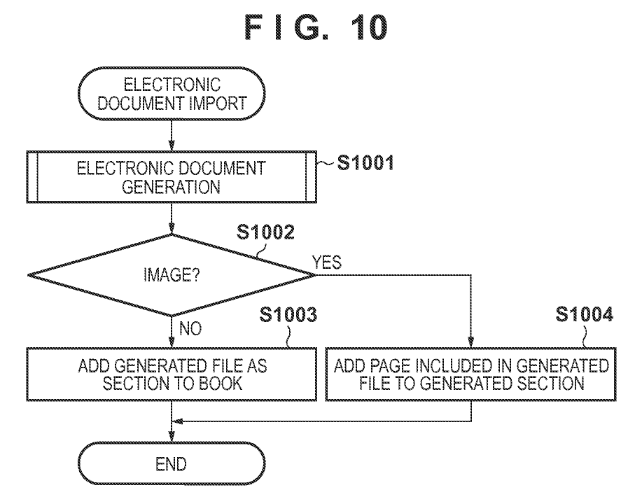

FIG. 10 is a flowchart illustrating an example of an electronic document import procedure.

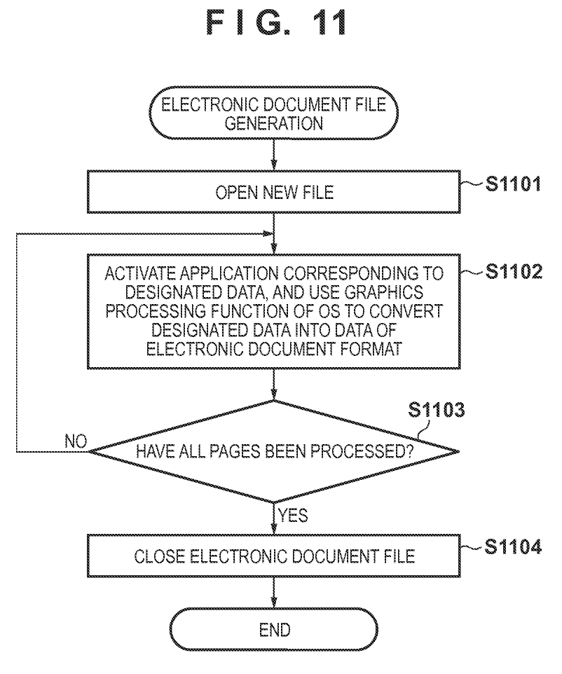

The bookbinding application 104 activates an application program which has generated designated application data. The bookbinding application 104 designates the electronic document writer 102 as a device driver, and causes the application program to print out the application data, thereby converting the data into electronic document data (step S1001). This processing will be described in detail later with reference to FIG. 11.

After the conversion to the electronic document data, the bookbinding application 104 determines whether the converted data is image data (step S1002). This determination can be performed based on the file extension of the application data under the Windows® OS. For example, the extension “bmp” represents Windows® bitmap data; “jpg”, jpeg-compressed image data; and “tiff”, tiff-format image data. Note that for such image data, it is possible to omit the processing in step S1001 since it is possible to directly generate an electronic document file from the image data without activating the application unlike in step S1001.

If the converted data is not image data (NO in step S1002), the bookbinding application 104 adds the electronic document file generated in step S1001 as a new section to the book of a currently opened book file (step S1003). In general, among the section attributes, for attributes common to the book attributes, the values of the book attributes are copied, and for the remaining attributes, default values defined in advance are set. The user, however, may select whether the attribute values of the lower layer are preferentially used.

If the converted data is image data (YES in step S1002), no new section is added in principle, and the bookbinding application 104 adds each document page included in the electronic document file generated in step S1001 to a designated section (step S1004). If the book file is a newly generated file, a new section is generated, and each page of the electronic document file is added as a page belonging to the section. Among the page attributes, for attributes common to the attributes of the upper layer, the attribute values of the upper layer are copied, and an attribute which is defined in the application data and inherited to the electronic document file is given a value defined in the application data. For example, when “N-up printing designation” is set in the application data, this attribute value is inherited. In this manner, a new book file is generated, or a new section is added. The user, however, may select whether the attribute values of the lower layer are preferentially used.

(Generation of Electronic Document File)

FIG. 11 is a flowchart illustrating a procedure of causing the bookbinding application 104 to generate an electronic document file using the electronic document writer 102 in step S1001 shown in FIG. 10.

The bookbinding application 104 generates a new electronic document file and opens it (step S1101). The bookbinding application 104 then activates the general application 101 corresponding to designated application data, and sets the electronic document writer 102 as a device driver to transmit an output command to the output module of the OS. The output module converts the received output command into data of the electronic document format by the electronic document writer 102, and outputs the converted data (step S1102). The output destination of the converted data is the electronic document file opened in step S1101. In this case, the data may be converted for each page. The bookbinding application 104 determines whether all the designated data have been converted (step S1103). If the conversion is not complete (NO in step S1103), the bookbinding application 104 repeats the conversion processing (step S1102) by the electronic document writer 102 for pages which have not been converted. If the conversion is complete (YES in step S1103), the bookbinding application 104 closes the electronic document file (step S1104). The electronic document file generated by the electronic document writer 102 in this manner is a file containing document data entities shown in FIG. 3.

(Example of Edit of Book File)

The above processing enables to generate a book file from application data. The sections and pages of the generated book file can undergo the following edit operations using the UI screen 900 shown in FIG. 9, which is displayed by the bookbinding application 104:

(1) Adding new section or page

(2) Delete

(3) Copy

(4) Cut

(5) Paste

(6) Move

(7) Change section name

(8) Reassign page number/name

(9) Set front cover

(10) Set interleaf

(11) Set index sheet

(12) Page layout of each document page (Change layout, add new blank page, and the like)

In addition, it is possible to perform an operation of canceling an executed edit operation and an operation of redoing a canceled operation.

These edit functions enable edit operations such as combining of a plurality of book files, rearrangement of sections and pages within a book file, deletion of sections and pages within a book file, layout change of a document page, and insertion of a interleaf and index sheet. Performing these operations reflect the operation results in the attributes shown in FIGS. 4 to 6 or in the structure of the book file. For example, if an operation of newly adding a blank page is performed, the blank page is inserted at a designated position. This blank page is handled as a document page. In addition, if the layout of a document page is changed, the changed contents are reflected in attributes such as the printing method, N-up printing, front cover/back cover, index sheet, interleaf, and section delimiting.

[Bookbinding Printing Settings in Bookbinding Printing]

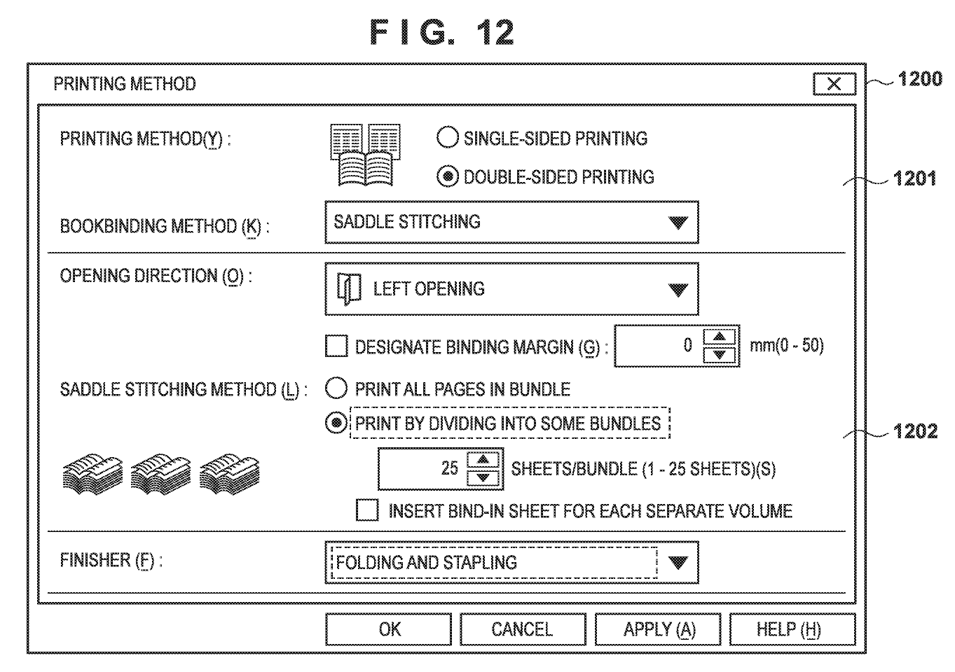

FIG. 12 shows a UI screen 1200 of “print settings” for making settings of bookbinding printing in the bookbinding application 104.

It is possible to set, through the UI screen 1200, the “printing method” attribute (No. 1 in FIG. 4A), and the “opening direction”, “binding margin”, “separate binding designation”, and “finisher” attributes of the “details of bookbinding” attribute (No. 10 in FIG. 4B) of the document setting information 403. The UI screen 1200 is activated by designating a submenu “Print Settings” (not shown) of a menu “Print Form” 904 of the UI screen 900 shown in FIG. 9, or designating a bookbinding printing menu using a “Print Settings” button (not shown) on a tool bar. Selecting “bookbinding printing” as a “printing method” 1201 on the UI screen 1200 enables to designate “detailed settings” 1202 of bookbinding printing. In the “detailed settings” 1202 of bookbinding printing, an opening direction, binding margin, separate binding method, and finisher are designated. For the separate binding method, the number of sheets to be bound, and a method of inserting a bind-in sheet in separate biding (whether to insert a bind-in sheet for each separate volume) are designated. For the finisher, folding, stapling (saddle stitching), and the like are designated as a finishing method in bookbinding printing.

[Sheet Insertion Settings in Bookbinding Printing]

FIG. 13 shows a UI screen 1300 of “front cover/interleaf settings” for designating a sheet insertion method in bookbinding printing by the bookbinding application 104.

It is possible to set, through the UI screen 1300, the “details of bookbinding” attribution (No. 10 in FIG. 4B), and the “insertion position”, “bind-in sheet”, and “front cover” attributes of the “front cover/back cover” attribute (No. 11 in FIG. 4B) of the document setting information 403. The UI screen 1300 is activated in the same manner as that described with reference to FIG. 12. A selected menu, however, is an insertion method. The UI screen 1300 enables to designate a sheet type/feed unit, and printing/non-printing of document data for a front cover in bookbinding printing (1301). It is also possible to designate an insertion position (sheet number), a sheet type/feed unit, and printing/non-printing of document data for an insertion sheet in bookbinding printing (1302). Furthermore, it is possible to designate the number of sheets to be inserted, a sheet type/feed unit, and printing/non-printing of document data for a bind-in sheet in bookbinding printing (1303).

A “split” button 1304 is prepared in the UI screen 1300. When the “split” button 1304 is selected, the insertion position of an insertion sheet, a feed unit for an insertion sheet and bind-in sheet are automatically input. For example, if a printer (a printer to undergo print settings) currently selected in the bookbinding application 104 is different from that recorded in the “preprint” attribute of the “details of bookbinding” attribute of the document setting information 403, the sheet number of a preprinted sheet is automatically input. More specifically, if second, third, sixth, and seventh pages to be printed as the printed materials of document data are printed for preprinting, the bookbinding application 104 stores their sheet numbers. When printing the same document data, the UI screen 1300 shown in FIG. 13 is displayed. When the split button 1304 is selected, 2, 3, 6, and 7 which correspond to the numbers of sheets stored as printed sheets for preprinting are automatically input as sheet numbers in the portion 1302. Furthermore, a feed unit (inserter) for inserting a sheet in the printer currently selected in the bookbinding application 104 is automatically selected. Note that before inputting the feed unit, the information of the feed unit may be acquired from the printer 107 to determine whether sheets have been set in the feed unit.

Note that an insertion sheet setting result in the UI screen 1300 is reflected in the UI screen 900 shown in FIG. 9. That is, the UI screen displays information for enabling to identify a target document page or sheet as an insertion sheet or bind-in sheet. For example, when a given page of document data is printed on a bind-in sheet, a character string “bind-in sheet” is displayed adjacent to a page number in the preview portion 902.

[Bind-In Sheet Setting Processing]

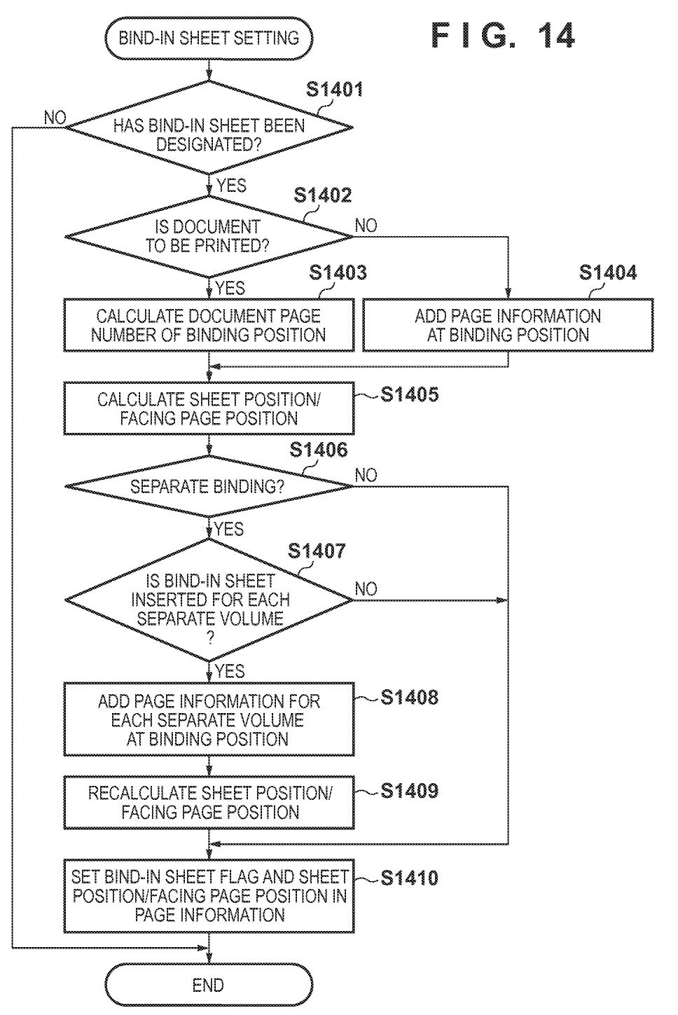

FIG. 14 is a flowchart illustrating a procedure example of processing of setting a bind-in sheet in the electronic document file 103 by the bookbinding application 104 in the document processing system.

The bookbinding application 104 determines whether a bind-in sheet has been designated through the UI screen 1300 shown in FIG. 13 (step S1401). If a bind-in sheet has been designated (YES in step S1401), the process advances to step S1402; otherwise (NO in step S1401), the bind-in sheet setting processing is terminated.

In step S1402, the bookbinding application 104 determines whether an instruction to print document data on a bind-in sheet has been given through the UI screen 1300 shown in FIG. 13. More specifically, the bookbinding application 104 determines whether the checkbox of “print document” is on in the bind-in sheet settings of the UI screen 1300 shown in FIG. 13. If document printing has been instructed (YES in step S1402), the process advances to step S1403; otherwise (NO instep S1402), the process advances to step S1404.

In step S1403, the bookbinding application 104 calculates the page number of document data to be laid out at a bind-in sheet position when laying out the document data on sheets in bookbinding printing. As an example of the calculation method, the pages of the document data are virtually imposed according to the settings of bookbinding printing. Pages to be printed on bind-in sheets are then specified using the number designated, in the UI screen 1300 shown in FIG. 13, as the number of bind-in sheets to be inserted. For example, it is recognized that four sheets are printed by imposing the document data of 16 pages according to the settings of bookbinding printing. If, for example, two is designated as the number of bind-in sheets to be inserted, the numbers of pages to be imposed on two inner ones of the four print sheets are calculated as the result of the processing in step S1403.

In step S1404, the bookbinding application 104 adds the page information 409 for a bind-in sheet at a position where the bind-in sheet is laid out. The added page information for the bind-in sheet does not include concrete contents of the document data.

In step S1405, the bookbinding application 104 calculates, for each page, a sheet number and facing page set number when laying out the document pages on sheets in bookbinding printing. Note that the processing in step S1405 virtually imposes the pages of the document data according to the settings of bookbinding printing, thereby calculating a sheet number and facing page set number indicating a position where each page is laid out. In step S1406, based on the number of sheets forming a separate volume which has been designated in the UI screen 1200 shown in FIG. 12, and the number of sheets of the document, the bookbinding application 104 determines whether the document is to undergo separate binding. If the document is to undergo separate binding (YES in step S1406), the process advances to step S1407; otherwise (NO in step S1406), the process advances to step S1410.

In step S1407, the bookbinding application 104 determines whether the method of inserting a bind-in sheet, which has been designated in the UI screen 1200 shown in FIG. 12, inserts a sheet for each separate volume. More specifically, the bookbinding application 104 determines whether the checkbox of “insert bind-in sheet for each separate volume” in the “detailed settings” 1202 of the UI screen 1200 shown in FIG. 12 is on. If a bind-in sheet is to be inserted for each separate volume (YES in step S1407), the process advances to step S1408; otherwise (NO in step S1407), the process advances to step S1410.

In step S1408, the bookbinding application 104 adds, for each separate volume, the page information 409 for a bind-in sheet at a position where the bind-in sheet is laid out. In step S1409, the bookbinding application 104 recalculates, for each page, a sheet number and facing page set number when laying out the document pages on sheets in bookbinding printing if a bind-in sheet is to be inserted for each separate volume. More specifically, if separate binding for generating a book by setting folded printed materials as a bookbinding unit, and stacking a plurality of bookbinding units on each other is designated, the number of sheets constituting one bookbinding unit is also designated. The processing in step S1409 is implemented for each bookbinding unit by imposing the pages of the document data according to the number of sheets constituting one bookbinding unit and the number of bind-in sheets to be inserted.

In step S1410, the bookbinding application 104 sets a bind-in sheet flag, sheet number, and facing page set number in the page setting information 411 of the document page. If the document undergoes separate binding, the bookbinding application 104 sets a bind-in sheet flag, sheet number, and facing page set number in the page setting information 411 of the document page recalculated in step S1409. On the other hand, if the document does not undergo separate binding, the bookbinding application 104 sets a bind-in sheet flag, sheet number, and facing page set number in the page setting information 411 of the document page calculated in step S1405. Note that executing the processing shown in FIG. 14 enables the bookbinding application 104 to recognize a page to be printed on a bind-in sheet, thereby displaying a character string “bind-in sheet” on the page recognized to be printed on the bind-in sheet.

[Page Movement/Deletion Processing Procedure]

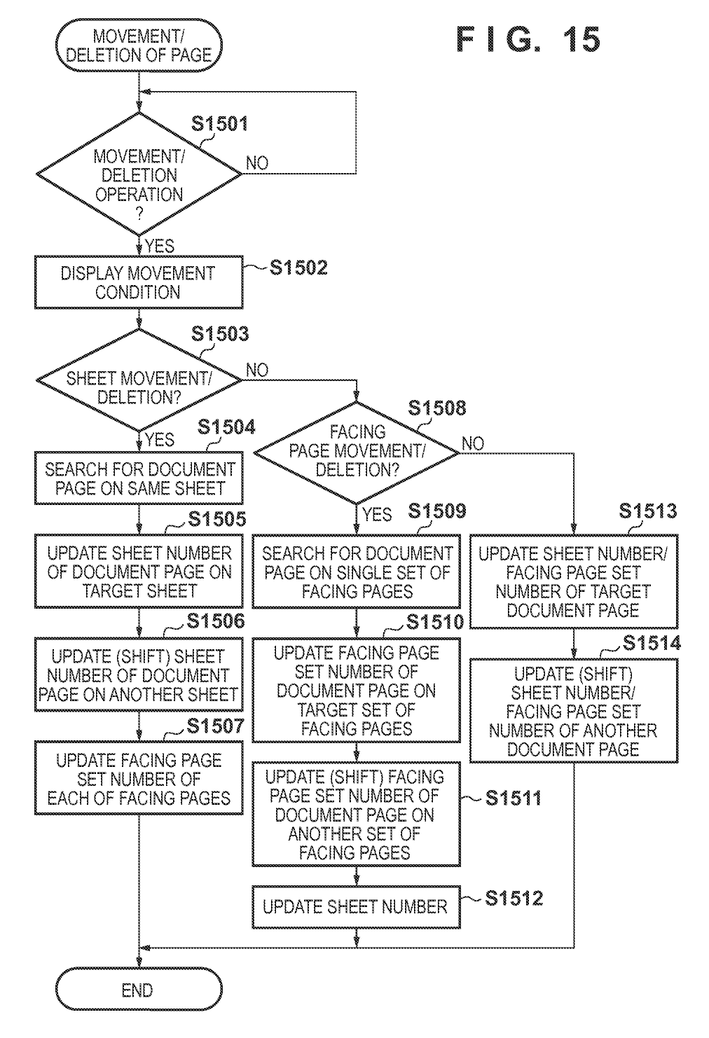

FIG. 15 is a flowchart illustrating a procedure example of processing when the bookbinding application 104 performs edit operations such as movement and deletion operations for the document pages of the electronic document file 103 including the settings of bookbinding printing in the document processing system.

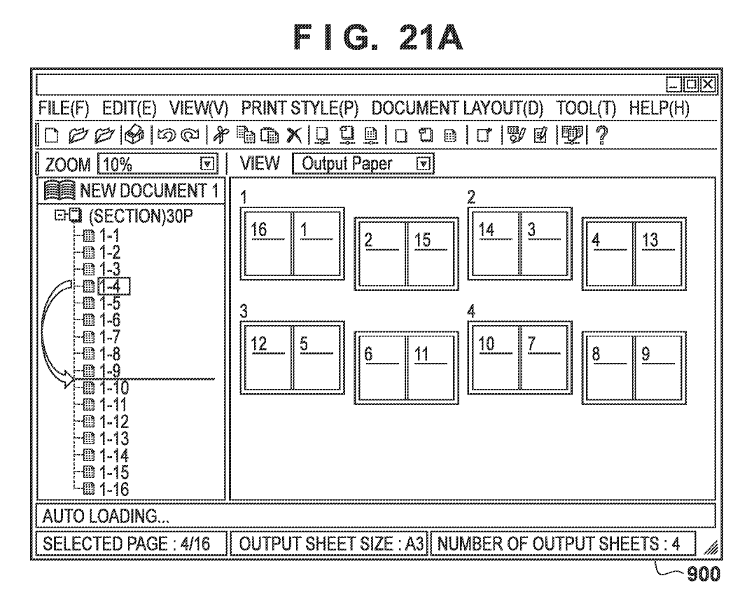

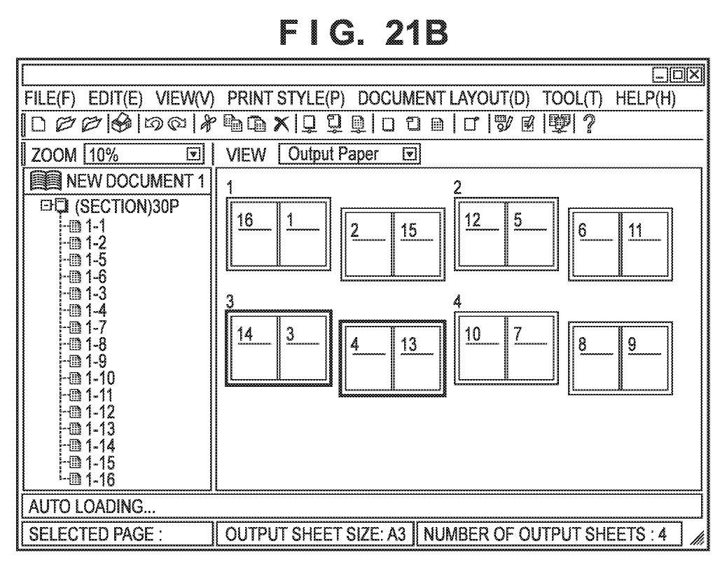

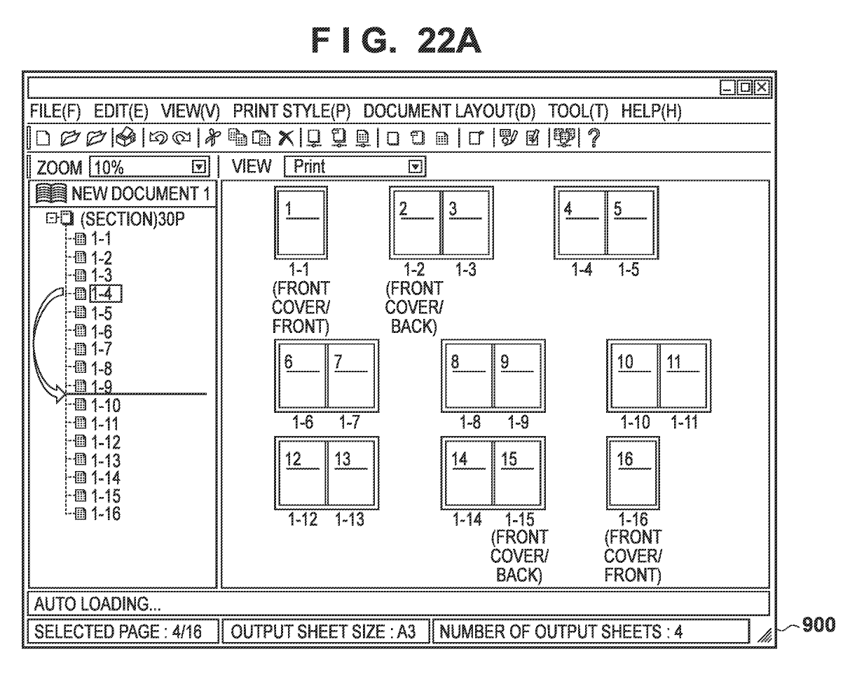

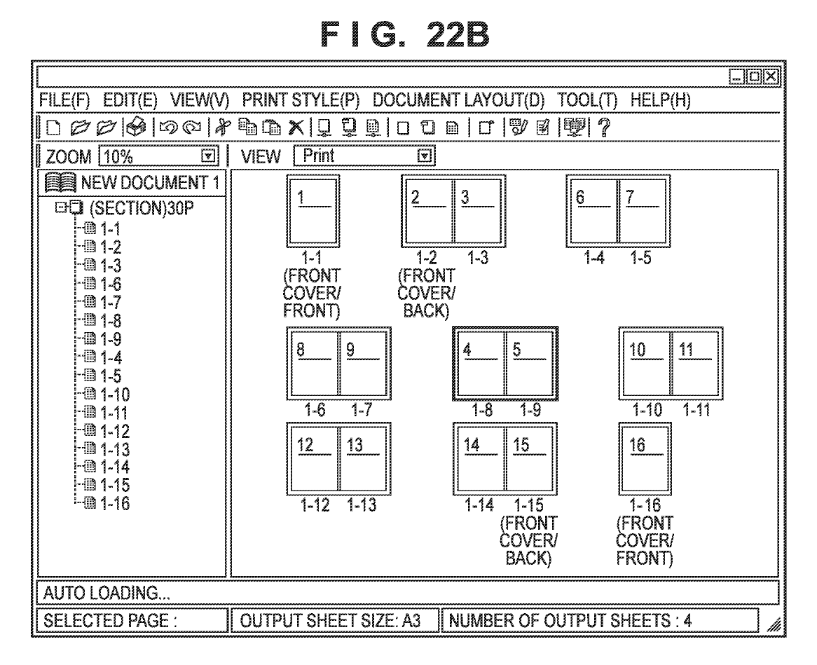

In describing the flowchart, document page movement UI screens in bookbinding printing which are exemplified in FIGS. 21A, 21B, 22A, and 22B are used. In “Output Paper” View shown in FIG. 21A and “Print” View shown in FIG. 22A, an example of a book file including 16 document pages is shown. That is, document data (a book file) includes a plurality of pages, and the preview image of each page is displayed according to the print settings.

FIG. 21A shows a case in which pages are moved for each sheet, and FIG. 21B shows the processing result. On the other hand, FIG. 22A shows a case in which pages are moved for each set of facing pages, and FIG. 22B shows the processing result. A detailed description will be provided below with reference to the flowchart shown in FIG. 15.

Based on the UI screen 900 shown in FIG. 9, the bookbinding application 104 determines whether an edit operation of moving or deleting a page has been performed (step S1501). If an edit operation of moving or deleting a page has been performed (YES in step S1501), the process advances to step S1502. If, for example, it is identified that the fourth document page has been moved (dragged and dropped) immediately before the 10th document page as shown in FIG. 21A or 22A, the process advances to step S1502.

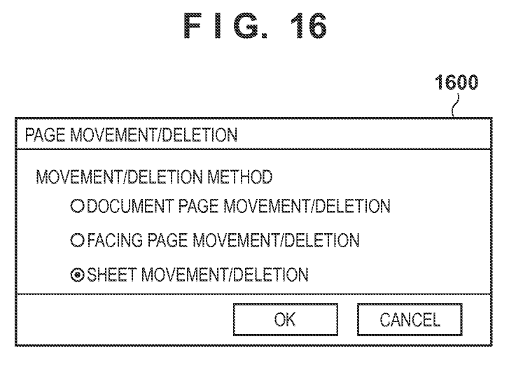

In step S1502, the bookbinding application 104 displays a UI screen 1600 shown in FIG. 16 (to be described later) for designating a movement or deletion condition.

In step S1503, the bookbinding application 104 determines whether the movement or deletion condition designated through the UI screen 1600 displayed in step S1502 indicates movement or deletion for each sheet. If the condition indicates movement or deletion for each sheet (YES in step S1503), the process advances to step S1504; otherwise (NO in step S1503), the process advances to step S1508.

In step S1504, based on the page setting information 411, the bookbinding application 104 searches for a document page having the same sheet number as that of the document page to be edited. In the example shown in FIG. 21A, third, 13th, and 14th pages are detected as document pages having the same sheet number as that of the fourth document page. That is, information of pages laid out on the second sheet (with a sheet number “2”) is detected.

In step S1505, the bookbinding application 104 updates the sheet number of the page setting information 411 of each of the document page to be edited and the pages found in step S1504 to the movement destination sheet number. In the example shown in FIG. 21A, the sheet number of each of the fourth, third, 13th, and 14th pages is updated to “3”.

In step S1506, the bookbinding application 104 updates the sheet number of the page setting information 411 of each of other document pages (document pages existing after the sheet to be moved or deleted) which are influenced by the update operation in step S1505. In the example shown in FIG. 21A, the sheet number of each of the fifth, sixth, 11th, and 12th pages is updated to “2”. That is, the sheet number of each document page laid out on the third sheet (with a sheet number “3”) before the update operation is updated to indicate that it is laid out on the second sheet (with a sheet number “2”).

In step S1507, the bookbinding application 104 updates the facing page set number of the page setting information 411 of each of facing pages which are influenced by the update operations in steps S1505 and S1506. More specifically, in FIG. 21A, the facing page set number of each of the fifth and 12th document pages is updated to “3”, and the facing page set number of each of the sixth and 11th document pages is updated to “4”. Furthermore, the facing page set number of each of the third and 14th document pages is updated to “5”, and the facing page set number of each of the fourth and 13th document pages is updated to “6”.

The state shown in FIG. 21A changes into a state shown in FIG. 21B in which the document pages (the third, 13th, and 14th pages) laid out on the same sheet as that of the fourth document page are moved immediately before the sheet on which the 10th document page is laid out.

In step S1508, the bookbinding application 104 determines whether the movement or deletion condition designated in step S1502 indicates movement or deletion for each set of facing pages. If the condition indicates movement or deletion for each set of facing pages (YES in step S1508), the process advances to step S1509; otherwise (NO in step S1508), the process advances to step S1513.

In step S1509, based on the page setting information 411, the bookbinding application 104 searches for a document page having the same facing page set number as that of the document page to be edited. In the example shown in FIG. 22A, the fifth page is detected as a document page having the same facing page set number as that of the fourth document page. That is, information of each of the third set of facing pages (with a facing page set number “3”) is detected.

In step S1510, the bookbinding application 104 updates the facing page set number of the page setting information 411 of each of the document page to be edited and the document page found in step S1509 to the movement destination facing page set number. In the example shown in FIG. 22A, the facing page set number of each of the fourth and fifth pages is updated to “5”. That is, the updated information indicates that the third set of facing pages (with a facing page set number “3”) before the update operation has been laid out as the fifth set of facing pages (with a facing page set number “5”).

In step S1511, the bookbinding application 104 updates the facing page set number of the page setting information 411 of each of other document pages (pages existing after the position of the facing pages to be moved or deleted) which are influenced by the update operation in step S1510. In the example shown in FIG. 22A, the facing page set number of each of the sixth and seventh pages is updated to “3”, and the facing page set number of each of the eighth and ninth pages is updated to “4”.

In step S1512, the bookbinding application 104 updates the sheet number of the page setting information 411 of a sheet which is influenced by the update operations in steps S1510 and S1511. More specifically, in FIG. 22A, the sheet number of each of the sixth and seventh document pages is updated to “2”, and the sheet number of each of the fourth and fifth document pages is updated to “3”.

The state shown in FIG. 22A changes into a state shown in FIG. 22B in which the document page (fifth page) laid out on the same facing page set as that of the fourth document page is moved immediately before the facing page set on which the 10th document page is laid out.

In step S1513, to perform movement/deletion for each document page, the bookbinding application 104 updates the sheet number and facing page set number of the document page to be edited. In step S1514, the bookbinding application 104 updates the sheet number and facing page set number of the page setting information 411 of each of other document pages which are influenced by the update operation in step S1513.

In this embodiment, a method of updating a sheet number and facing page set number when moving or deleting a document page has been described above. The contents of the page data link 412 of the page information 409, however, may be updated without updating a sheet number or facing page set number.

In FIGS. 21A, 21B, 22A, and 22B, an edit operation is received using the tree portion of the book structure on the left side of the screen. An edit operation, however, may be received by selecting the preview image of a page.

Although movement or deletion of a document page has been explained as an edit operation in this embodiment, the present invention is equally applicable to other edit operations (addition, copy, paste, and the like of a document page).

The above-described conventional technique does not consider any document edit operation in bookbinding printing. In bookbinding printing, document data are imposed in the order of facing page sets. That is, the combination of document data imposed on one sheet does not comply with the page order of the document data. If, for example, the page order of the document data of eight pages is 1→2→3→4→5→6→7→8, the document data are imposed on sheets in bookbinding printing so that the eighth, first, second, and seventh pages are imposed on the first sheet, and the sixth, third, fourth, and fifth pages are imposed on the second sheet. In such a page edit operation (movement or deletion) in bookbinding printing, the relationship between document data laid out on sheets or that between document data laid out on facing page sets may be required to be maintained rather than simply moving or deleting the document data.

Especially in a case in which bookbinding printing is implemented by inserting a preprinted sheet, the layout relationship between sheets and document data may be important. According to the flowchart shown in FIG. 15, it is possible to select in a page edit operation (movement or deletion) in bookbinding printing whether to perform the edit operation while maintaining the layout of the document data on a sheet or to perform the edit operation while maintaining the layout of the document data on facing pages. This enables a more flexible edit operation in bookbinding printing.

FIG. 16 shows an example of the UI screen 1600 displayed when the bookbinding application 104 performs an edit operation of moving or deleting a document page in bookbinding printing. In the UI screen 1600, to move or delete a document page, one of the following edit methods is received from the user:

a simple document page edit operation (ignore the relationship between document data laid out on facing pages or a sheet);

an edit operation while maintaining the relationship between document pages laid on a single set of facing pages; and

an edit operation while maintaining the relationship between document pages laid on the same sheet.

FIGS. 21A, 21B, 22A, and 22B each show a display example of the UI screen 900 when the bookbinding application 104 moves a specific document page based on the settings of bookbinding printing. For an original book file which includes 16 document pages and for which the settings of bookbinding printing have been made, FIG. 21A shows the UI screen in “Output Paper” View. FIG. 22A shows the UI screen in “Print” View.

FIG. 21B shows a result of moving the fourth document page of the original book file immediately before the 10th document page with respect to FIG. 21A. FIG. 21B shows a result of moving the document page when “sheet movement/deletion” (movement while maintaining the relationship between document pages laid out on the same sheet) is selected through the UI screen 1600 shown in FIG. 16. FIG. 22B shows a result of moving the fourth page of the original book file immediately before the 10th document page with respect to FIG. 22A. FIG. 22B shows a result of moving a document page when “facing page movement/deletion” (movement while maintaining the relationship between document pages laid on a single set of facing pages) is selected through the UI screen 1600 shown in FIG. 16.

[Book File Output Example]

The book file generated/edited as described above is finally printed out. When the user selects a file menu through the UI screen 900 of the bookbinding application 104 shown in FIG. 9 and then selects printing, a designated output device prints out data.

To do this, the bookbinding application 104 saves a currently opened book file, and passes a file path as a save destination to the electronic document despooler 105. The electronic document despooler 105 converts the attributes of the book file acquired from the save destination into the output command of the OS, for example, a Windows® GDI command, and imposes the document data of the book file. The electronic document despooler 105 then transmits the imposed document data to the output module (for example, GDI). The output module generates print data corresponding to a device using the designated printer driver 106, and transmits it to the corresponding device.

That is, the graphic engine (not shown) of the output module loads the printer driver 106 prepared for each printer from the external memory 211 into the RAM 202, and sets the printer driver 106 as an output destination. The output module converts the received GDI function into a DDI function, and outputs it to the printer driver 106. The printer driver 106 converts the DDI function received from the output module into a control command recognizable by the printer, for example, PDL (Page Description Language). The converted printer control command is output, as print data, to the printer 107 via the interface 21 using a system spooler loaded into the RAM 202 by the OS.

[Bookbinding Printing Imposition Processing Procedure]

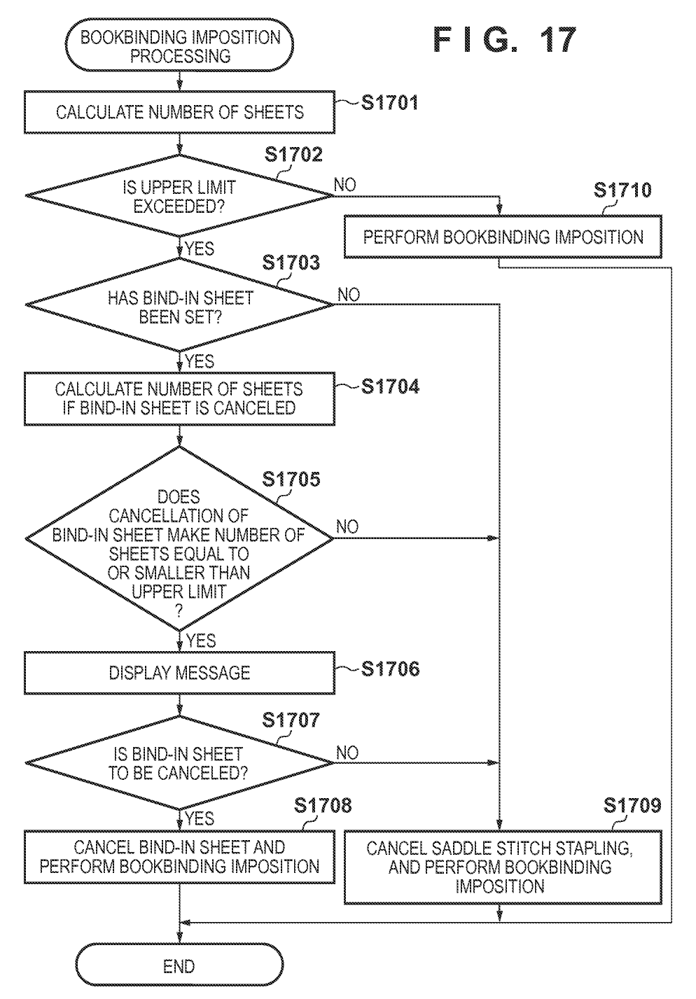

FIG. 17 is a flowchart illustrating a procedure example of processing of imposing document data in saddle stitch printing by the electronic document despooler 105 in the document processing system.

Upon receiving a book file from the bookbinding application 104, the electronic document despooler 105 calculates the number of sheets in bookbinding printing (step S1701). In step S1702, the electronic document despooler 105 determines whether the number of sheets calculated in step S1701 exceeds an upper limit of the number of sheets to be stapled (saddle-stitched) by the printer 107. If the upper limit is exceeded (YES in step S1702), the process advances to step S1703; otherwise (NO in step S1702), the process advances to step S1710.

In step S1703, the electronic document despooler 105 determines whether “bind-in sheet” has been set in the “details of bookbinding” attribute (No. 10 in FIG. 4B) of the document setting information 403. If “bind-in sheet” has been set (YES in step S1703), the process advances to step S1704; otherwise (NO in step S1703), the process advances to step S1709.

In step S1704, the electronic document despooler 105 calculates the number of sheets in bookbinding printing if the bind-in sheet setting is canceled. In step S1705, the electronic document despooler 105 determines whether the number of sheets calculated in step S1704 is equal to or smaller than the upper limit of the number of sheets to be saddle-stitched (stapled). If the calculated number of sheets is equal to or smaller than the upper limit (YES in step S1705), the process advances to step S1706; otherwise (NO in step S1705), the process advances to step S1709.

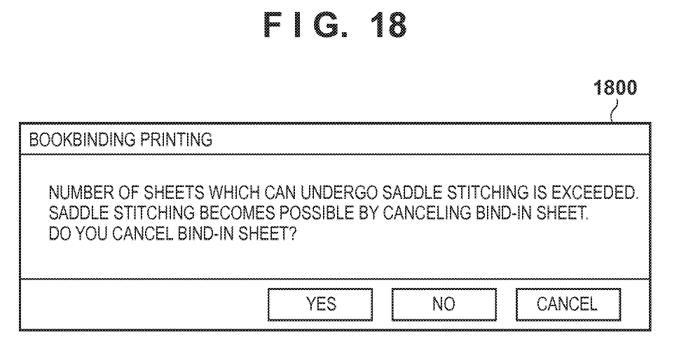

In step S1706, the electronic document despooler 105 displays a UI screen 1800 shown in FIG. 18 for selecting whether to cancel the bind-in sheet via the bookbinding application 104. In step S1707, the electronic document despooler 105 receives a selection result on the UI screen 1800 in step S1706 via the bookbinding application 104, and determines whether cancellation of the bind-in sheet has been instructed. If cancellation has been designated (YES in step S1707), the process advances to step S1708; otherwise (NO in step S1707), the process advances to step S1709.

In step S1708, the electronic document despooler 105 cancels the bind-in sheet, and performs bookbinding imposition processing for the document data. In step S1709, the electronic document despooler 105 cancels the saddle stitch setting, and executes bookbinding imposition processing for the document data. To cancel the saddle stitch setting (if a “YES” button in FIG. 18 is selected), the electronic document despooler 105 cancels the saddle stitch setting of the “details of bookbinding” attribute (No. 10 in FIG. 4B) of the document setting information 403.

In step S1710, the electronic document despooler 105 performs bookbinding imposition processing for document data without changing the saddle stitch setting or bind-in sheet setting.

FIG. 18 shows an example of the UI screen 1800 displayed in step S1706 of FIG. 17 in the bookbinding application 104. In bookbinding printing for which the upper limit of the number of sheets to be saddle-stitched is exceeded (YES in step S1705), it is possible to instruct, through the UI screen 1800, whether to cancel the bind-in sheet to perform printing.

The conventional technique can insert a sheet at a front cover position in bookbinding printing by the document processing system, but cannot insert a sheet at the central position of a book. That is, it is impossible to change a sheet for “bind-in sheet” existing at “binding position (facing page position)” in bookbinding printing. It is also impossible to insert another sheet as an insertion sheet between sheets. The present invention enables to insert a sheet independently of the number of sheets in bookbinding printing, thereby allowing more flexible settings in bookbinding printing.

### Second Embodiment

In the first embodiment, as shown in FIG. 17, the UI screen 1800 used to cancel the bind-in sheet by the electronic document despooler 105 is displayed if the upper limit of the number of sheets in bookbinding printing is exceeded. If the cancellation of the bind-in sheet is designated, saddle stitch printing is performed by canceling the bind-in sheet setting.

Instead of the above method, the electronic document despooler 105 may display a UI screen for canceling the bind-in sheet or insertion sheet. If cancellation of the bind-in sheet or insertion sheet is designated, the bind-in sheet or insertion sheet setting can be canceled.

In the following embodiment, part of the embodiment wherein an electronic document despooler 105 cancels a bind-in sheet or insertion sheet, which is different from the first embodiment, will be mainly described in detail with reference to the accompanying drawings.

[Bookbinding Printing Imposition Processing Procedure]

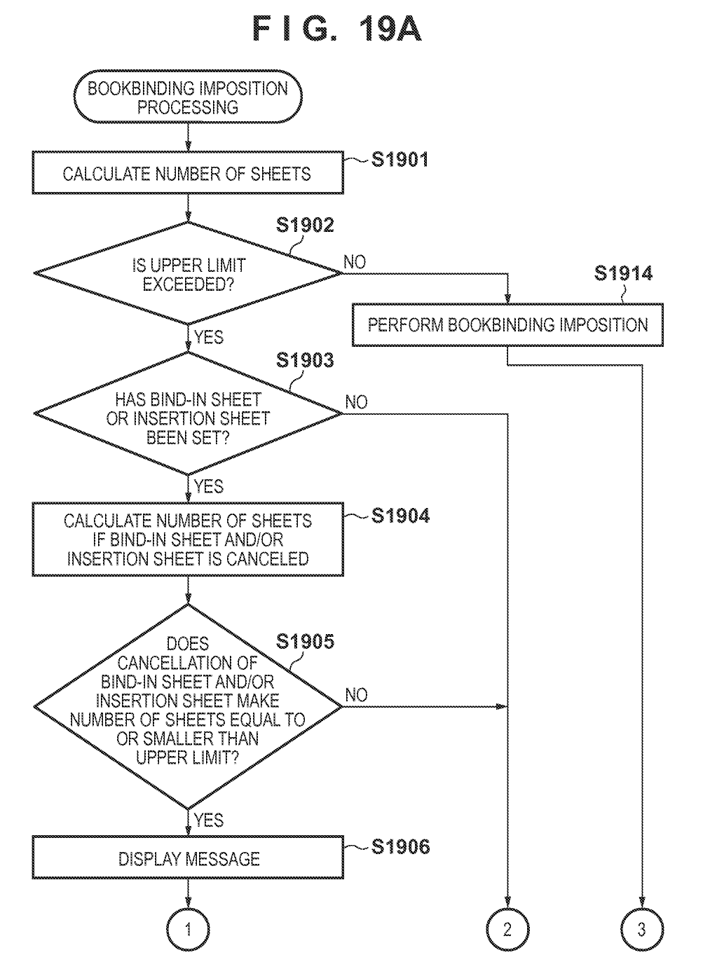

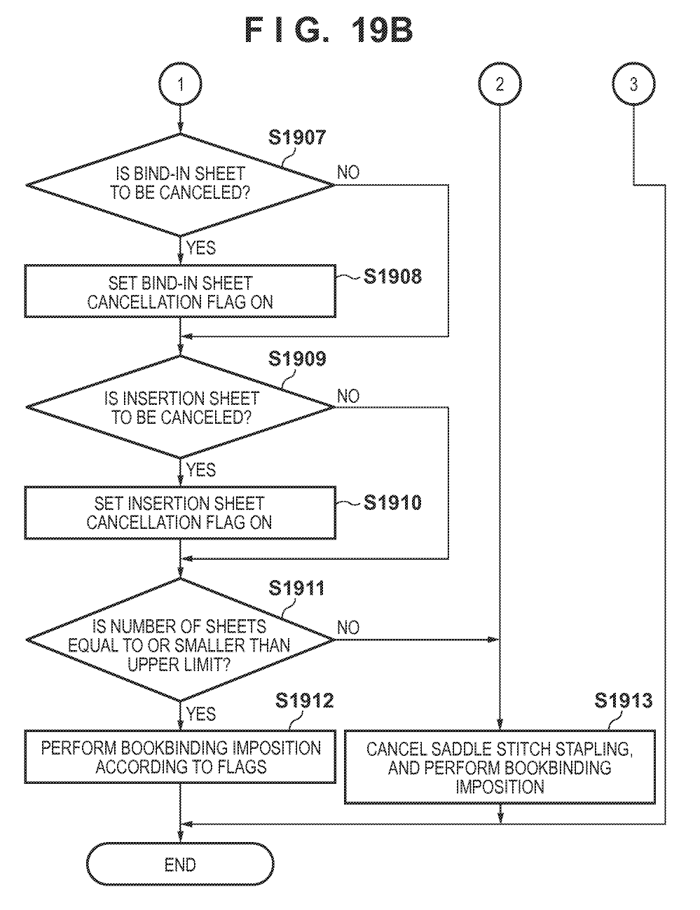

FIG. 19 is a flowchart illustrating a procedure example of processing of imposing document data in saddle stitch printing by the electronic document despooler 105 in a document processing system.

Note that processing in steps S1901 and S1902 is the same as that in steps S1701 and S1702 of FIG. 17, and a description thereof will be omitted. If an upper limit of the number of sheets is exceeded (YES in step S1902), the process advances to step S1903; otherwise (NO in step S1902), the process advances to step S1914.

In step S1903, the electronic document despooler 105 determines whether “bind-in sheet” or “insertion sheet” has been set in the “details of bookbinding” attribute (No. 10 in FIG. 4B) of document setting information 403. If “bind-in sheet” or “insertion sheet” has been set (YES in step S1903), the process advances to step S1904; otherwise (NO in step S1903), the process advances to step S1913.

In step S1904, the electronic document despooler 105 calculates the number of sheets in bookbinding printing if the bind-in sheet setting is canceled, the insertion sheet setting is canceled, or both of them are canceled. In step S1905, the electronic document despooler 105 determines whether at least one of the numbers of sheets calculated in step S1904 is equal to or smaller than the upper limit. If at least one of the numbers of sheets is equal to or smaller than the upper limit (YES in step S1905), the process advances to step S1906; otherwise (NO in step S1905), the process advances to step S1913.

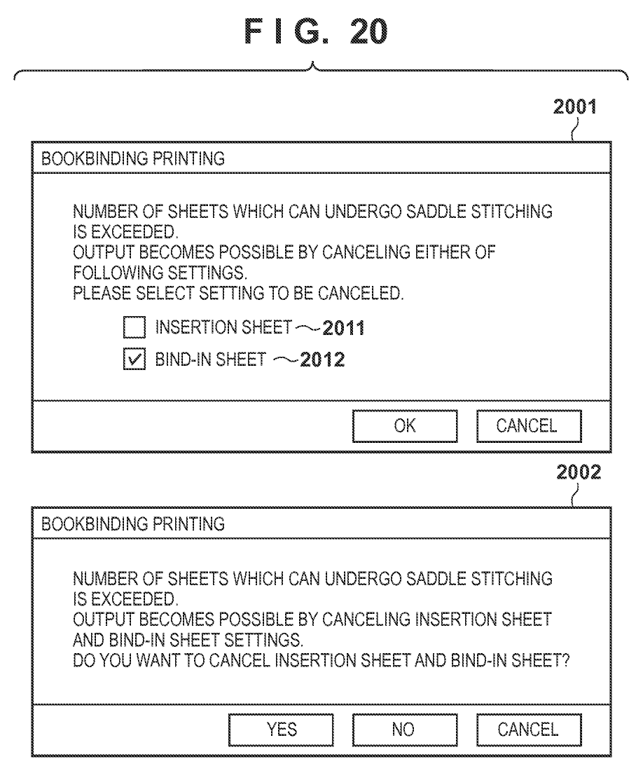

In step S1906, the electronic document despooler 105 displays a UI screen shown in FIG. 20 for selecting whether to cancel the bind-in sheet or insertion sheet via a bookbinding application 104. The electronic document despooler 105 displays a UI screen 2001 or UI screen 2002 according to the determination result in step S1905. An instruction indicating whether to cancel the insertion setting of the bind-in sheet or insertion sheet is received from the user through the UI screen.

In step S1907, the electronic document despooler 105 receives, via the bookbinding application 104, the selection result through the UI screen displayed in step S1906, and determines whether cancellation of the bind-in sheet has been instructed. If cancellation has been instructed (YES in step S1907), the process advances to step S1908; otherwise (NO in step S1907), the process advances to step S1909.

In step S1908, the electronic document despooler 105 sets a flag indicating whether to cancel designation of the bind-in sheet “ON” (a default setting is “OFF”). In step S1909, the electronic document despooler 105 receives, via the bookbinding application 104, the selection result through the UI screen displayed in step S1906, and determines whether cancellation of the insertion sheet has been instructed. If cancellation has been designated (YES in step S1909), the process advances to step S1910; otherwise (NO in step S1909), the process advances to step S1911.

In step S1910, the electronic document despooler 105 sets a flag indicating whether to cancel designation of the insertion sheet “ON” (a default setting is “OFF”). In step S1911, the electronic document despooler 105 determines whether the number of sheets is equal to or smaller than the upper limit of the number of sheets to be saddle-stitched by the printer 107. If the number of sheets is equal to or smaller than the upper limit (YES in step S1911), the process advances to step S1912; otherwise (NO in step S1911), the process advances to step S1913.

In step S1912, the electronic document despooler 105 cancels the bind-in sheet or insertion sheet according to the cancellation flag of the bind-in sheet or insertion sheet, thereby performing bookbinding imposition processing for the document data. In step S1913, the electronic document despooler 105 cancels the saddle stitch setting, thereby executing bookbinding imposition processing for the document data. Note that to cancel the saddle stitch setting, the saddle stitch setting of the “details of bookbinding” attribute (No. 10 in FIG. 4B) of the document setting information 403 is canceled.

In step S1914, the electronic document despooler 105 executes bookbinding imposition processing for the document data without changing the saddle stitch setting or bind-in sheet setting.

FIG. 20 shows examples of the UI screen displayed in step S1906 of FIG. 19 in the bookbinding application 104. In bookbinding printing for which the upper limit of the number of sheets to be saddle-stitched is exceeded, it is possible to instruct, through this UI screen, whether to cancel the bind-in sheet or insertion sheet to perform printing.

Note that contents displayed on the UI screen are switched according to the determination result in step S1905. That is, if the number of sheets becomes equal to or smaller than the upper limit by canceling either the bind-in sheet setting or insertion sheet setting, the UI screen 2001 is displayed. On the other hand, if the number of sheets becomes equal to or smaller than the upper limit by canceling both the bind-in sheet setting and the insertion sheet setting, the UI screen 2002 is displayed.

The UI screen 2001 displays checkboxes 2011 and 2012 for respectively designating cancellation of the insertion sheet and bind-in sheet. In this example, only the checkbox for the setting which is canceled to make the number of sheets equal to or smaller than the upper limit is displayed. An instruction to cancel both the insertion sheet and the bind-in sheet is received through the UI screen 2002.

As described above, if the electronic document despooler 105 displays a UI screen used to cancel the bind-in sheet or insertion sheet, and cancellation of the bind-in sheet or insertion sheet is designated, the bind-in sheet or insertion sheet setting is canceled. In this embodiment, it is also possible to obtain the same effects as those in the first embodiment.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-074886, filed Mar. 28, 2012, which is hereby incorporated by reference herein in its entirety.

What is claimed is:

1. An information processing apparatus for generating print data based on document data, comprising:
a receiving unit configured to receive, in bookbinding printing for generating a book by folding a bundle of a plurality of sheets overlapping each other into two, an instruction to insert an insertion sheet to the folded bundle; and
a generation unit configured to generate, in response to the instruction to insert the insertion sheet which has been received by said receiving unit, print data for outputting a book in which the insertion sheet has been inserted to inner side of the folded bundle by stacking a bundle of printed materials based on settings of the bookbinding printing and the insertion sheet on each other, and folding the bundle into two.

2. The apparatus according to claim 1, further comprising
a setting unit configured to receive, as a type of sheet to be used as the insertion sheet, a setting of a type of sheet different from a type of sheet to be used for the printed materials.

3. The apparatus according to claim 1, wherein said receiving unit further receives an instruction indicating whether to print a page on the insertion sheet.

4. The apparatus according to claim 1, wherein said receiving unit further receives the number of insertion sheets.

5. The apparatus according to claim 1, wherein if separate binding for generating a book by stacking bookbinding units each as folded printed materials on each other is designated, said receiving unit further receives an instruction indicating whether to insert the insertion sheet for each bookbinding unit.

6. The apparatus according to claim 1, further comprising
a display unit configured to display preview images of a plurality of pages constituting the document data,
wherein said display unit identifiably displays pages, among the plurality of pages, to be printed on the insertion page.

7. An information processing method of generating print data based on document data, comprising:
receiving, in bookbinding printing for generating a book by folding a bundle of a plurality of sheets overlapping each other into two, an instruction to insert an insertion sheet to the folded bundle; and
generating, in response to the instruction to insert the insertion sheet which has been received in the receiving step, print data for outputting a book in which the insertion sheet has been inserted to inner side of the folded bundle by stacking a bundle of printed materials based on settings of the bookbinding printing and the insertion sheet on each other, and folding the bundle into two.

8. The method according to claim 7, further comprising
receiving, as a type of sheet to be used as the insertion sheet, a setting of a type of sheet different from a type of sheet to be used for the printed materials.

9. The method according to claim 7, wherein an instruction indicating whether to print a page on the insertion sheet is further received in the receiving step.

10. The method according to claim 7, wherein in the receiving step, the number of insertion sheets is further received.

11. The method according to claim 7, wherein if separate binding for generating a book by stacking bookbinding units each as folded printed materials on each other is designated, an instruction indicating whether to insert the insertion sheet for each bookbinding unit is further received in the receiving step.

12. The method according to claim 7, further comprising
displaying preview images of a plurality of pages constituting the document data,
wherein pages, among the plurality of pages, to be printed on the insertion page are identifiably displayed in the display step.

13. A non-transitory computer-readable medium storing a program for causing a computer to function as
a receiving unit configured to receive, in bookbinding printing for generating a book by folding a bundle of a plurality of sheets overlapping each other into two, an instruction to insert an insertion sheet to the folded bundle; and
a generation unit configured to generate, in response to the instruction to insert the insertion sheet which has been received by the receiving unit, print data for outputting a book in which the insertion sheet has been inserted to inner side of the folded bundle by stacking a bundle of printed materials based on settings of the bookbinding printing and the insertion sheet on each other, and folding the bundle into two.

14. The medium according to claim 13, wherein the program causes the computer to further function as a setting unit configured to receive, as a type of sheet to be used as the insertion sheet, a setting of a type of sheet different from a type of sheet to be used for the printed materials.

15. The medium according to claim 13, wherein the receiving unit further receives an instruction indicating whether to print a page on the insertion sheet.

16. The medium according to claim 13, wherein the receiving unit further receives the number of insertion sheets.

17. The medium according to claim 13, wherein if separate binding for generating a book by stacking bookbinding units each as folded printed materials on each other is designated, the receiving unit further receives an instruction indicating whether to insert the insertion sheet for each bookbinding unit.

18. The medium according to claim 13, wherein
the program causes the computer to further function as a display unit configured to display preview images of a plurality of pages constituting the document data, and
the display unit identifiably displays pages, among the plurality of pages, to be printed on the insertion page.
